(19) United States
(12) Patent Application Publication
(10) Pub. No.: US 2024/0295038 A1
(43) Pub. Date: Sep. 5, 2024

(54) METAL-IMPREGNATED CARBON MATERIALS

(71) Applicants: Long Qi, Ames, IA (US); Wenyu Huang, Ames, IA (US); Sen Zhang, Crozet, VA (US); Zhouyang Yin, Fremont, CA (US); Lun An, Ames, IA (US); Kanika Lalit, Ames, IA (US)

(72) Inventors: Long Qi, Ames, IA (US); Wenyu Huang, Ames, IA (US); Sen Zhang, Crozet, VA (US); Zhouyang Yin, Fremont, CA (US); Lun An, Ames, IA (US); Kanika Lalit, Ames, IA (US)

(21) Appl. No.: 18/593,685

(22) Filed: Mar. 1, 2024

Related U.S. Application Data
(60) Provisional application No. 63/449,157, filed on Mar. 1, 2023.

(51) Int. Cl. C25B 11/075; C25B 1/23

(52) U.S. Cl. CPC C25B 11/075; C25B 1/23

(57) ABSTRACT

A metal-impregnated carbon material includes a mesoporous carbon matrix including a metal M. The metal M is bonded directly to the carbon matrix, M is bonded directly to an atom A that is bonded directly to the carbon matrix, or a combination thereof. At each occurrence, A is independently chosen from N, O, P, S, and B.

### CROSS-REFERENCE TO RELATED APPLICATION

This application claims the benefit of priority to U.S. Provisional Patent Application Ser. No. 63/449,157 filed Mar. 1, 2023, the disclosure of which is incorporated herein in its entirety by reference.

### STATEMENT OF GOVERNMENT SUPPORT

This invention was made with Government support under DE-AC02-07CH11358 awarded by the Department of Energy and by CBET-2004808 awarded by the National Science Foundation. The U.S. Government has certain rights in this invention.

### BACKGROUND

The conversion and utilization of CO₂ is highly demanded on the verge of technology revolution towards carbon neutrality and cyclic economy. Catalytic systems that would transform CO₂ into commodity chemicals can not only mitigate CO₂ footprint but also create new streams of feedstock supply, which may reshape the landscape of chemical manufacturing. Electrocatalytic CO₂ reduction reaction (CO₂RR) is an emerging technology that meets these requirements and has attracted enormous attention. The resulting CO can be subsequently converted to longer-chain hydrocarbons and oxygenates via well-established Fischer-Tropsch or tandem electrochemical conversion. The scaled application of CO₂RR requires catalytic systems to be energy-efficient and readily scalable, using earth-abundant elements.

Various catalytic materials have been explored, among which single-atom catalysts demonstrated great potentials for selective CO₂RR to CO product. However, there are significant synthetic challenges in preparing single-atom catalysts for the scaled application of CO₂RR. First, the desirable catalytic materials need to present largely accessible surface area and effective exposure of single-atom sites of high loading, rendering the electrochemical process amenable for high current-density operation. Second, the accurate understanding of structure-property relationship requires the generalized anchoring of single-atom sites with uniform short- and long-range structures crossing a broad range of metal compositions. However, most known CO₂RR catalysts are of relatively low surface area and/or low metal loading, limiting the amount of surface-exposed active sites and mass transfer.

### SUMMARY OF THE INVENTION

Various aspects of the present invention provide a carbon material. The carbon material includes a mesoporous carbon matrix that includes a metal M. The metal M is bonded directly to the carbon matrix, M is bonded directly to an atom A that is bonded directly to the carbon matrix, or a combination thereof. At each occurrence A is independently chosen from N, O, P, S, and B.

Various aspects of the present invention provide a carbon material. The carbon material includes a mesoporous carbon matrix including a metal M. The metal M is bonded directly to the carbon matrix, M is bonded directly to a nitrogen atom that is bonded directly to the carbon matrix, or a combination thereof. The metal M is Ni^{II}, M is 0.1 wt % to 5 wt % of the carbon matrix, and the carbon material has a Faradaic Efficiency for reduction of CO₂ to CO of 90% to 99% from −0.8 V to −1.4 V, or from −0.2 V to −1.6 V, or from 0 V to −5 V.

Various aspects of the present invention provide an electrolytic cell. The electrolytic cell includes an electrode and/or an electrolyte that includes a carbon material including a mesoporous carbon matrix that includes a metal M. The metal M is bonded directly to the carbon matrix, M is bonded directly to an atom A that is bonded directly to the carbon matrix, or a combination thereof. At each occurrence A is independently chosen from N, O, P, S, and B.

Various aspects of the present invention provide an electrolytic cell. The electrolytic cell includes an anode, a cathode, an ion exchange membrane separating the anode and the cathode, and an electrolyte solution at least partially immersing the anode and the cathode. The anode, the cathode, the electrolyte solution, or a combination thereof, includes a carbon material including a mesoporous carbon matrix including a metal M. The metal M is bonded directly to the carbon matrix, M is bonded directly to an atom A that is bonded directly to the carbon matrix, or a combination thereof. At each occurrence A is independently chosen from N, O, P, S, and B.

Various aspects of the present invention provide a method of using an electrolytic cell. The method includes applying an electrical potential across an anode and a cathode of an electrolytic cell. The anode, the cathode, an electrolyte solution of the electrolytic cell, or a combination thereof includes a carbon material including a mesoporous carbon matrix including a metal M. The metal M is bonded directly to the carbon matrix, M is bonded directly to an atom A that is bonded directly to the carbon matrix, or a combination thereof. At each occurrence A is independently chosen from N, O, P, S, and B.

Various aspects of the present invention provide a method of electrochemical carbon dioxide reduction. The method includes applying an electrical potential across an anode and a cathode of an electrolytic cell to form CO. The anode, the cathode, an electrolyte solution of the electrolytic cell, or a combination thereof includes a carbon material and is in contact with CO₂. The carbon material includes a mesoporous carbon matrix including a metal M. The metal M is bonded directly to the carbon matrix, M is bonded directly to a nitrogen atom that is bonded directly to the carbon matrix, or a combination thereof. The metal M is Ni^{II}, M is 0.1 wt % to 5 wt % of the carbon matrix, and the carbon material has a Faradaic Efficiency for reduction of CO₂ to CO of 90% to 99% from −0.8 V to −1.4 V, or from −0.2 V to −1.6 V, or from 0 V to −5 V.

Various aspects of the present invention provide a method of making a carbon material. The method includes chelating metal M with an organic amine. The method includes combining a carbon source and a removable pore former with the chelated metal, to form a mixture. The method includes heating the mixture to form a solid. The method includes carbonizing the solid, to form a carbon material precursor. The method includes removing the removable pore former from the carbon material precursor, to form the carbon material. The carbon material includes a mesoporous carbon matrix that includes a metal M. The metal M is bonded directly to the carbon matrix, M is bonded directly to an atom A that is bonded directly to the carbon matrix, or a combination thereof. At each occurrence A is independently chosen from N, O, P, S, and B.

Various aspects of the carbon material of the present invention and methods of using the same have various advantages over other materials and methods. For example, in various aspects of the present invention, the use of an organic amine for chelation with the metal can allow metal sites to remain isolated during formation of the carbon material. In various aspects of the present invention, the method of forming the carbon material can include the formation of an ordered mesoporous architecture that can enable the efficient exposure of metal sites with improved mass transfer properties, as compared to other single-site metal heterogeneous catalysts. In various aspects of the present invention, the uniform local structure of the carbon material metal sites can make it possible to rapidly benchmark catalytic performance, such as for CO₂RR. In various aspects of the present invention, the metal loading of the carbon material, the surface area of the carbon material, or a combination thereof, can be higher than that of other single-site metal heterogeneous catalysts. In various aspects of the present invention, the selectivity, stability, durability across a broad potential range, current density, or a combination thereof, of the carbon material during CO₂RR can be higher or improved compared to that of other catalysts, such as compared to other single-site metal heterogeneous catalysts. In various aspects of the present invention, the method of electrochemically reducing carbon dioxide with the electrolytic cell can successfully reduce carbon dioxide over a wide concentration, such as a concentration of 1%-100%. In various aspects of the present invention, the method of electrochemically reducing carbon dioxide with the electrolytic cell can preferentially reduce carbon dioxide to CO over conversion of other materials present with the CO₂ such as SO₂, SO₃, NO₂, NO₃, or a combination thereof. In various aspects of the present invention, the carbon material can have proximate nitrogen atoms therein (e.g., by forming the carbon material from one or more organic amines that include at least two nitrogen atoms per molecule), which can result in improved performance when used in an electrolytic cell (such as for CO₂RR). In various aspects, organic amines having two or more nitrogen atoms per molecule can have improved chelating performance with the metal and can form polymers of organic amine/metal complexes.

### BRIEF DESCRIPTION OF THE FIGURES

The drawings illustrate generally, by way of example, but not by way of limitation, various aspects of the present invention.

FIG. 1A illustrates various organic amines, in accordance with various aspects.

FIG. 1B illustrates various carbon sources, in accordance with various aspects.

FIGS. 2A-I illustrates high-angle annular dark-field scanning transmission electron microscopy (HAADF STEM) images of various metal single-atom catalysts, with FIG. 2A illustrating a low magnification image of Ni-NAC (NAC=nitrogen assembly carbon), and with FIGS. 2B-I illustrating atomic resolution images of (2B) Ni-NAC, (2C) Fe-NAC, (2D) Co-NAC, (2E) Cu-NAC, (2F) Ru-NAC, (2G) Rh-NAC, (2H) Pd-NAC, and (2I) Pt-NAC, in accordance with various aspects.

FIGS. 3A-E illustrate product distribution from CO₂RR catalyzed by (3A) Fe-NAC, (3B) Cu-NAC, (3C) Co-NAC, (3D) Ni-NAC, and (3E) NAC-800 catalyst at different reduction potentials, in accordance with various aspects.

FIG. 3F illustrates CO₂RR reduction current density of various catalysts at various reduction potentials, in accordance with various aspects.

FIG. 4A illustrates CO Faradaic efficiency and current density with Ni-NAC catalyst in flow cell at various potentials, in accordance with various aspects.

FIG. 4B illustrates CO Faradaic efficiency and current density with Ni-NAC catalyst in flow cell for 14 hours, in accordance with various aspects.

FIG. 5 illustrates electrochemical CO₂ reduction performance of Ni-NACs synthesized using various hard templates, in accordance with various aspects.

FIG. 6 illustrates chemical structures for various heteroatom sources, in accordance with various aspects.

FIG. 7 illustrates electrochemical CO₂ reduction performance of various heteroatom-doped Ni-NAC catalysts, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Carbon Material.

Various embodiments of the present invention provide a carbon material that includes a mesoporous carbon matrix. The mesoporous carbon matrix includes a metal M. The metal M can be bonded directly to the carbon matrix, M can be bonded directly to an atom A that is bonded directly to the carbon matrix, or a combination thereof. At each occurrence A can be independently chosen from O, P, N, and S (e.g., at each occurrence of atom A, atom A can be O, atom A can be N, atom A can be P, or atom A can be S). In various aspects, the carbon material can be used as a single-site heterogeneous catalyst, such as a single-site heterogeneous catalyst that catalyzes electrochemical reduction. In various aspects, the carbon material can catalyze electrochemical conversion of CO₂ to CO, of a mixture of a hydrogen source and CO₂ to CO and H₂, or a combination thereof.

Carbon can form any suitable proportion of the carbon material. For example, carbon can be 40 wt % to 99.9 wt % of the carbon material, 65 wt % to 75 wt %, or less than or equal to 99.9 wt % and greater than or equal to 40 wt % and less than, equal to, or greater than 42 wt %, 44, 46, 48, 50, 52, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 88, 90, 92, 94, 96, 98, or 99 wt %.

The metal M in the carbon matrix can have any suitable coordination number. The metal M in the carbon matrix can have a coordination number of 3. The metal M in the carbon matrix can have a coordination number of 4. In various aspects, the carbon matrix can include at least some metal M having a coordination number of 3 and at least some metal M having a coordination number of 4.

The metal M can be bonded directly to the carbon matrix, M can be bonded directly to an atom A that is bonded directly to the carbon matrix, or a combination thereof. The metal M can be bonded to the carbon matrix as M-C^{M}₄, C^{M}₃-M-AC^{M}, C^{M}₂-M-(AC^{M})₂, C^{M}-M-(AC^{M})₃, M-(AC^{M})₄, M-C^{M}₃, C^{M}₂-M-AC^{M}, C^{M}-M-(AC^{M})₂, M-(AC^{M})₃, or a combination thereof, wherein at each occurrence C^{M} is independently chosen from a carbon atom of the carbon matrix. The metal M can be bonded to the carbon matrix as C^{M}-M-(AC^{M})₃, wherein at each occurrence C^{M} is independently chosen from a carbon atom of the carbon matrix. The metal M can be bonded to the carbon matrix as M-C^{M}₄, C^{M}₃-M-NC^{M}, C^{M}₂-M-(NC^{M})₂, C^{M}-M-(NC^{M})₃, M-(NC^{M})₄, M-C^{M}₃, C^{M}₂-M-NC^{M}, C^{M}-M-(NC^{M})₂, M-(NC^{M})₃, or a combination thereof, wherein at each occurrence C^{M} is independently chosen from a carbon atom of the carbon matrix. The metal M can be bonded to the carbon matrix as C^{M}-M-(NC^{M})₃, wherein at each occurrence C^{M} is independently chosen from a carbon atom of the carbon matrix.

In various aspects, the carbon material can be substantially free of metal nanoparticles that include metal M. In other aspects, the carbon material can include metal nanoparticles that include metal M. Metal nanoparticles that includes metal M can be any suitable proportion of the total amount of metal M in the carbon material, such as 0 wt %, or 0 wt % to 5 wt %, or 0 wt % to 99.999 wt %, or less than or equal to 99.999 wt % and greater than or equal to 0 wt % and less than, equal to, or less than 0.001 wt %, 0.01, 0.1, 0.5, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, 99, 99.9, or 99.99 wt %.

The mesoporous carbon matrix includes mesopores, which are pores having a diameter of 2 nm to 50 nm. The mesoporous carbon matrix can include exclusively mesopores or can additionally include micropores having a diameter of less than 2 nm. The mesoporous carbon matrix can include any suitable distribution of mesopores and micropores; for example, the mesoporous carbon matrix can include a proportion of mesopores based on pore volume that is 100% of the total volume of pores in the mesoporous carbon matrix, or 5% to 100% mesopores, or 50% to 100% mesopores, or 80% to 100% mesopores, or less than or equal to 100% and greater than or equal to 5% and less than, equal to, or greater than 10%, 15, 20, 25, 30, 35, 40, 45, 50, 55, 60, 65, 70, 75, 80, 85, 90, or 95%. The mesoporous carbon matrix can have a total volume of micropores that is 0.01% to 70% of the total pore volume, or 1% to 50%, or less than or equal to 70% and greater than or equal to 0.01% and less than, equal to, or greater than 0.05%, 0.1, 0.5, 1, 2, 3, 4, 5, 10, 15, 20, 25, 30, 35, 40, 45, 50, 55, 60, or 65%. The mesoporous carbon matrix can include pores having any suitable diameter (e.g., d₅₀), such as 1 nm to 50 nm, or 5 nm to 15 nm, or less than or equal to 50 nm and greater than or equal to 1 nm and less than, equal to, or greater than 2 nm, 3, 4, 5, 6, 7, 8, 9, 10, 11, 12, 13, 14, 15, 16, 18, 20, 22, 24, 26, 28, 30, 32, 34, 36, 38, 40, 42, 44, 46, or 48 nm. The mesoporous carbon matrix can have any suitable surface area, such as a surface area of 100 m²/g to 2500 m²/g, or 600 m²/g to 950 m²/g, or equal to or less than 2500 m²/g and greater than or equal to 100 m²/g and less than, equal to, or greater than 150 m²/g, 200, 250, 300, 350, 400, 450, 500, 550, 600, 620, 640, 660, 680, 700, 720, 740, 760, 780, 800, 820, 840, 860, 880, 900, 920, or 940 m²/g.

The metal M can be any suitable type of metal. For example, M can be a rare earth metal, a precious metal, or a transition metal. The metal M can be a rare earth metal, such as Nd, Tb, Y, La, Dy, Ce, Pr, Sm, Sc, Gd, Eu, Er, Tm, Yb, Ho, Lu, or Pm. The metal M can be a precious metal, such as Au, Ag, Pt, Pd, Ru, Rh, Os, Ir, Ge, Be, In, Ga, Te, or Bi. The metal M can be a transition metal, such as Zn, Cu, Fe, Cr, Ni, Co, Mn, V, Ti, Rh, Mo, Tc, Ag, Pd, Ru, Nb, Zr, Pt, Os, Re, Sc, Ir, W, Hf, Ta, Cd, Au, Y, Hg, Hs, Mt, Sg, Ds, Rg, Cn, Db, Rf, or Bh. The metal M can be Al, Sn, Ga, In, Ge, Fe, Co, Ni, Cu, Pt, Pd, Ru, or Rh. The metal M can be Fe^{III}, Fe^{II}, Co^{II}, Ni^{II}, Cu^{II}, Pd^{II}, or Pt^{II}. The metal M can be Ni^{II}. The metal M can form any suitable proportion of the carbon matrix. For example, the metal M can be 0.1 wt % to 40 wt % of the carbon matrix, 0.1 wt % to 5 wt %, or less than or equal to 40 wt % and greater than or equal to 0.1 wt % and less than, equal to, or greater than 0.2, 0.3, 0.4, 0.6, 0.8, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.5, 6, 7, 8, 9, 10, 12, 14, 16, 18, 20, 22, 24, 26, 28, 30, 32, 34, 36, or 38 wt %.

The mesoporous carbon matrix can include doping with nitrogen, oxygen, phosphorus, sulfur, boron, or a combination thereof. The mesoporous carbon matrix can include nitrogen atoms, oxygen atoms, phosphorus atoms, sulfur atoms, boron atoms, or a combination thereof, bonded thereto. The mesoporous carbon matrix can include A atoms (wherein A is N, O, S, P, or B) bonded between M and carbon atoms of the carbon matrix, A atoms bonded to the carbon matrix that are free of bonds to M, or a combination thereof. The mesoporous carbon matrix can include A atoms bonded between M and carbon atoms of the carbon matrix. Atom A can form any suitable proportion of the carbon matrix, such as 0.1 wt % to 60 wt %, 10 wt % to 15 wt %, or less than or equal to 60 wt % and greater than or equal to 0.1 wt % and less than, equal to, or greater than 0.5 wt %, 1, 2, 3, 4, 5, 6, 7, 8, 9, 10, 11, 12, 13, 14, 15, 16, 17, 18, 19, 20, 22, 24, 26, 28, 30, 35, 40, 45, 50, or 55 wt %. For example, nitrogen atoms, phosphorus atoms, oxygen atoms, sulfur atoms, boron atoms, or a combination thereof, can form any suitable proportion of the carbon matrix, such as 0.1 wt % to 60 wt %, 10 wt % to 15 wt %, or less than or equal to 60 wt % and greater than or equal to 0.1 wt % and less than, equal to, or greater than 0.5 wt %, 1, 2, 3, 4, 5, 6, 7, 8, 9, 10, 11, 12, 13, 14, 15, 16, 17, 18, 19, 20, 22, 24, 26, 28, 30, 35, 40, 45, 50, or 55 wt %. For example, nitrogen atoms can form any suitable proportion of the carbon matrix, such as 0.1 wt % to 60 wt %, 10 wt % to 15 wt %, or less than or equal to 60 wt % and greater than or equal to 0.1 wt % and less than, equal to, or greater than 0.5 wt %, 1, 2, 3, 4, 5, 6, 7, 8, 9, 10, 11, 12, 13, 14, 15, 16, 17, 18, 19, 20, 22, 24, 26, 28, 30, 35, 40, 45, 50, or 55 wt %.

The mesoporous carbon matrix can have any suitable C:A atomic ratio, such as an atomic ratio of 0.5 to 1000, 1 to 100, 2 to 50, 3 to 20, 7 to 10.7, or less than or equal to 1000 and greater than or equal to 0.5 and less than, equal to, or greater than 1, 2, 3, 4, 5, 6, 6.5, 7, 7.2, 7.4, 7.6, 7.8, 8, 8.2, 8.4, 8.6, 8.8, 9, 9.2, 9.4, 9.6, 9.8, 10, 10.2, 10.4, 10.6, 10.8, 11, 12, 13, 14, 15, 16, 18, 20, 25, 30, 35, 40, 45, 50, 75, 100, 150, 200, 250, 300, 350, 400, 450, 500, 600, 700, 800, or 900. The mesoporous carbon matrix can have any suitable C:N, C:P, C:O, C:B, or C:S atomic ratio, such as an atomic ratio of 0.5 to 1000, 7 to 10.7, or less than or equal to 1000 and greater than or equal to 0.5 and less than, equal to, or greater than 1, 2, 3, 4, 5, 6, 6.5, 7, 7.2, 7.4, 7.6, 7.8, 8, 8.2, 8.4, 8.6, 8.8, 9, 9.2, 9.4, 9.6, 9.8, 10, 10.2, 10.4, 10.6, 10.8, 11, 12, 13, 14, 15, 16, 18, 20, 25, 30, 35, 40, 45, 50, 75, 100, 150, 200, 250, 300, 350, 400, 450, 500, 600, 700, 800, or 900.

In various aspects, the carbon material catalyzes electrochemical reduction of CO₂ to CO. In various aspects, the carbon material can preferentially catalyze electrochemical reduction of CO₂ to CO over electrochemical conversion of a hydrogen source and CO₂ to CO and H₂. In various aspects, the carbon material can catalyze electrochemical reduction of CO₂ to CO wherein the CO₂ is in a gaseous composition that includes 1% to 100% CO₂, such as 3% to 100%, such as 5% to 100%, or less than or equal to 100%, greater than or equal to 1%, and less than, equal to, or greater than 1%, 2, 3, 4, 5, 6, 7, 8, 9, 10, 12, 14, 16, 18, 20, 25, 30, 35, 40, 45, 50, 55, 60, 65, 70, 75, 80, 85, 90, 95, 96, 97, 98, or 99%. The gaseous composition can further include SOₓ (e.g., SO₂ and/or SO₃), NOₓ (e.g., NO₂ and/or NO₃), or a combination thereof, wherein the carbon material electrochemically converts the CO₂ to CO preferentially over electrochemical conversion of the SOx, NOx, or a combination thereof. The carbon material can have any suitable Faradaic Efficiency (FE) for reduction of CO₂ to CO, such as an FE of 0.1% to 100% from −0.1 V to −10 V, such as an FE from −0.1 V to −10 V, or from 0 V to −5 V, or from −0.2 V to −1.6 V, of 10% to 100%, or 20% to 99%, or 40% to 99%, or of equal to or less than 100% and greater than or equal to 0.1% and less than, equal to, or greater than 0.5%, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, 99, 99.5, or 99.9%. The carbon material can have an FE for reduction of CO₂ to CO of 20% to 100%, 40% to 99%, or 90% to 99% from −0.8 V to −1.4 V, such as an FE from −0.8 V to −1.4 V, or from −0.2 V to −1.6 V, or from 0 V to −5 V of less than or equal to 99% and greater than or equal to 90% and less than, equal to, or greater than 90.5%, 91, 91.5, 92, 92.5, 93, 93.5, 94, 94.5, 95, 95.5, 96, 96.5, 97, 97.5, 98, or 98.5%.

### Electrolytic Cell.

Various aspects of the present invention provide an electrolytic cell. The electrolytic cell can include an electrode and/or an electrolyte that includes the carbon material of the present invention. The electrolytic cell can include a cathode, an anode, and an electrolyte solution (e.g., an electrolyte slurry) that at least partially immerses the cathode and/or the anode, wherein the cathode, the anode, the electrolyte, or a combination thereof, includes the carbon material of the present invention. The cathode can include the carbon material, the anode can include the carbon material, the electrolyte solution can include the carbon material, or a combination thereof. An electrode that includes the carbon material can include a coating that includes the carbon material. The electrolytic cell can further include an ion-exchange membrane that separates the electrode including the carbon material from another electrode.

In various aspects, an electrolyte solution in the electrolytic cell includes CO₂(g), and the electrolytic cell including the carbon material can be used to electrochemically reduce the CO₂ to CO. In various aspects, the CO₂ can be in a gaseous composition that includes 1% to 100% CO₂, such as 3% to 100%, such as 5% to 100%, or less than or equal to 100%, greater than or equal to 1%, and less than, equal to, or greater than 1%, 2, 3, 4, 5, 6, 7, 8, 9, 10, 12, 14, 16, 18, 20, 25, 30, 35, 40, 45, 50, 55, 60, 65, 70, 75, 80, 85, 90, 95, 96, 97, 98, or 99%. The gaseous composition can further include SOₓ (e.g., SO₂ and/or SO₃), NOₓ (e.g., NO₂ and/or NO₃), or a combination thereof, wherein the electrolytic cell electrochemically converts the CO₂ to CO preferentially over electrochemical conversion of the SOₓ, NOₓ, or a combination thereof.

Various aspects of the present invention provide a method of using the electrolytic cell. The method can include applying an electrical potential across an anode and a cathode of the electrolytic cell. Applying the electrical potential across the anode and the cathode can be used to carry out any suitable reaction, depending on the type of carbon material included in the electrochemical cell and depending on the types of starting materials included in the electrochemical cell.

Various aspects of the present invention provide a method of using the electrolytic cell to reduce carbon dioxide. The method can include applying an electrical potential across an anode and a cathode of the electrolytic cell, wherein the anode, the cathode, an electrolyte solution of the electrolytic cell, or a combination thereof includes a carbon material and is in contact with CO₂, to form CO. The carbon material can be any suitable embodiment of the carbon material of the present invention. For example, the carbon material can include a mesoporous carbon matrix including a metal M. The metal M can be bonded directly to the carbon matrix, M can be bonded directly to a nitrogen atom that is bonded directly to the carbon matrix, or a combination thereof. The metal M can be Ni^{II}, M can be 0.1 wt % to 5 wt % of the carbon matrix, and the carbon material can have a Faradaic Efficiency for reduction of CO₂ to CO of 90% to 99% from −0.8 V to −1.4 V, or from −0.2 V to −1.6 V, or from 0 V to −5 V. In various aspects, the CO₂ can be in a gaseous composition that includes 1% to 100% CO₂, or 3% to 100% CO₂, or 5% to 100%, or less than or equal to 100%, greater than or equal to 1%, and less than, equal to, or greater than 2%, 3, 4, 5, 6, 7, 8, 9, 10, 12, 14, 16, 18, 20, 25, 30, 35, 40, 45, 50, 55, 60, 65, 70, 75, 80, 85, 90, 95, 96, 97, 98, or 99%. The method can selectively convert CO₂ in the presence of impurities such as NOₓ and SOₓ. The gaseous composition can further include SOₓ (e.g., SO₂ and/or SO₃), NOₓ (e.g., NO₂ and/or NO₃), or a combination thereof, wherein the electrolytic cell electrochemically converts the CO₂ to CO preferentially over electrochemical conversion of the SOₓ, NOₓ, or a combination thereof.

The source of the gaseous composition including CO₂ can be any suitable source, such as direct air capture, industrial manufacturing, or steam generator for power generation.

### Method of Making a Carbon Material.

Various aspects of the present invention provide a method of making the carbon material of the present invention. The method can include chelating metal M with an organic amine. The method can include combining a carbon source and a removable pore former with the chelated metal, to form a mixture. The method can include heating the mixture to form a solid. The method can include carbonizing the solid, to form a carbon material precursor. The method can include removing the removable pore former from the carbon material precursor, to form the carbon material. The carbon material includes a mesoporous carbon matrix. The mesoporous carbon matrix include a metal M. The metal M can be bonded directly to the carbon matrix, M can be bonded directly to an atom A that is bonded directly to the carbon matrix, or a combination thereof. At each occurrence A can be independently chosen from O, P, N, and S.

Chelating the organic amine and the metal M can include chelating the organic amine and an organometallic compound that includes M and one or more counterions. The one or more counterions can be any suitable one or more counterions. For example, the organometallic compound can include M and one or more acetylacetonate counterions.

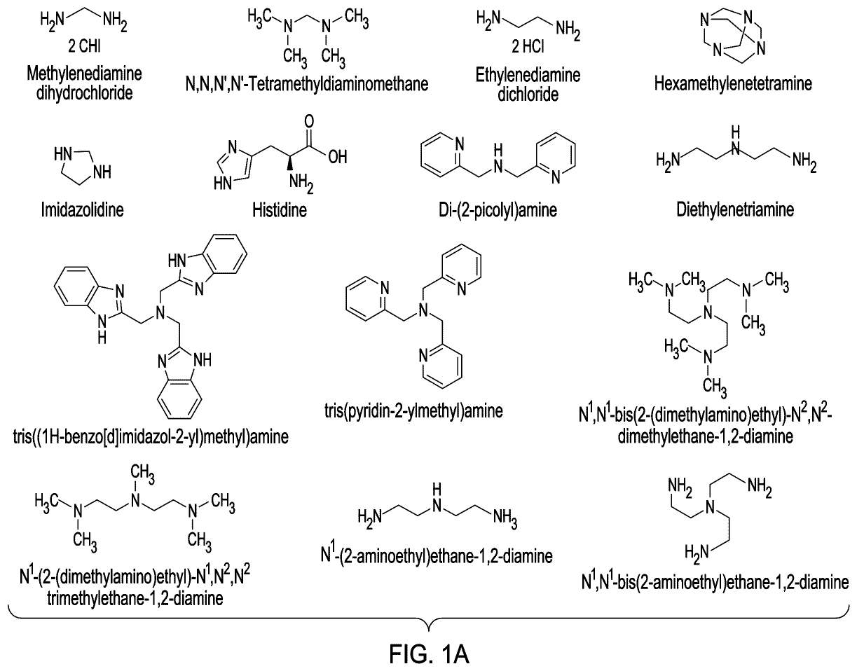

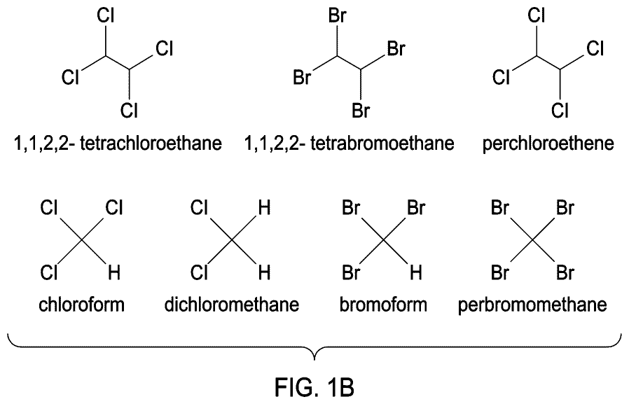

The organic amine can be any suitable organic amine. More than one organic amine can be used, or a single organic amine can be used. The organic amine can be H₂N—(CH₂)ₙ—NH₂, wherein n is an integer in the range of 1 to 10, or methylenediamine dihydrochloride, N,N,N′N′-tetramethyldiaminomethane, ethylenediamine dichloride, hexamethylenetetramine, imidazolidine, histidine, di-(2-picolyl)amine, diethylenetriamine, tris((1H-benzo[d]imidazole-2-yl)methyl)amine, tris(pyridine-2-ylmethyl)amine, N¹,N¹-bis(2-(dimethylamine)ethyl)-N²,N²-dimethylethane-1,2-diamine, Ni-(2-(dimethylamine)ethyl)-N¹,N²,N²-trimethylethane-1,2-diamine, Ni-(2-aminoethyl)ethane-1,2-diamine, N¹,N¹-bis(2-aminoethyl)ethane-1,2-diamine, 2-hydroxyethylamine, 2-mercaptoethylamine, 2-(diphenylphosphino)ethylamine, 1,2-bis(diphenylphosphino)ethane, or a combination thereof. The organic amine can be ethylenediamine. FIG. 1A illustrates various suitable organic amines. In various aspects, at least one of the organic amines includes two or more nitrogen atoms in the same molecule. In various aspects, forming the carbon material using an organic amine including at least two nitrogen atoms in the same molecule can result in a carbon material that has proximate nitrogen atoms therein, which can provide better properties, such as improved performance of an electrolytic cell including the carbon material in one or more electrodes thereof (e.g., for CO₂RR). Not being limited by theory, in various aspects, an organic amine having two or more nitrogen atoms per molecule can more effectively chelate with the metal M and can form a polymer of organic amine/metal complexes with the carbon source.

The carbon source can be any suitable carbon source for forming the carbon material. For example, the carbon source can be carbon tetrahalide, methylene chloride, 1,1,2,2-tetrachloroethane, 1,1,2,2-tetrabromoethane, perchloroethene, chloroform, bromoform, perbromomethane, or a combination thereof. The carbon source can be carbon tetrachloride. FIG. 1B illustrates various suitable carbon sources.

The removable pore former can be any suitable material that can form pores in the carbon material and that can be removed from the carbon material. For example, the removable pore former can include a pyrolyzable material, a meltable material, a heat-degradable material, an acid- or base-etchable material, or a combination thereof. For example, the removable pore former can include silica, such as mesoporous silica, which can be removed via etching with acid or base. The removable pore former, such as mesoporous silica, can have a pore diameter (e.g., d₅₀) 1 nm to 50 nm, or 5 nm to 15 nm, or less than or equal to 50 nm and greater than or equal to 1 nm and less than, equal to, or greater than 2 nm, 3, 4, 5, 6, 7, 8, 9, 10, 11, 12, 13, 14, 15, 16, 18, 20, 22, 24, 26, 28, 30, 32, 34, 36, 38, 40, 42, 44, 46, or 48 nm. The removable pore former, such as mesoporous silica, can have any suitable particle size, such as a particle size of 20 nm to 500 nm, or 20 nm to 150 nm, or less than or equal to 500 nm and greater than or equal to 20 nm and less than, equal to, or greater than 30 nm, 40, 50, 60, 70, 80, 90, 100, 110, 120, 130, 140, 150, 160, 180, 200, 250, 300, 350, 400, or 450 nm. The removable pore former, such as mesoporous silica, can have any suitable pore volume (e.g., as determined via mercury porosimetry), such as 0.4 cm³/g to 1.5 cm³/g, 0.8 cm³/g to 1 cm³/g, or less than or equal to 1.5 cm³/g and greater than or equal to 0.4 cm³/g, or less than, equal to, or greater than 0.5 cm³/g, 0.6, 0.7, 0.8, 0.82, 0.84, 0.86, 0.88, 0.9, 0.92, 0.94, 0.96, 0.98, 1, 1.1, 1.2, 1.3, or 1.4 cm³/g. In various aspects, the pore former can be SBA-15, KIT-6, MCM-48, or a combination thereof. The use of different removable pore formers can result in distinct microscopic structures and mesoporous configurations of the resulting carbon material.

The heating of the mixture to form the solid can include heating the mixture to any suitable temperature, such as a temperature of 50° C. to 150° C., 80° C. to 100° C., or less than or equal to 150° C. and greater than or equal to 50° C., 55, 60, 65, 70, 72, 74, 76, 78, 80, 81, 82, 83, 84, 85, 86, 87, 88, 89, 90, 91, 92, 93, 94, 95, 96, 97, 98, 99, 100, 102, 104, 106, 108, 110, 115, 120, 125, 130, 135, 140, or 145° C. Heating the mixture to form the solid can be performed under the ambient atmosphere, or under an atmosphere enriched by or including predominantly nitrogen, sulfur, phosphorus, oxygen, boron, or a combination thereof, such as to dope or further dope the formed carbon material with N, S, P, O atoms, or a combination thereof. Heating the mixture to form the solid can include heating under any suitable pressure, such as ambient pressure. Heating the mixture to form the solid can be performed for any suitable duration, such as 10 h to 20 h, or less than or equal to 20 h and greater than or equal to 10 h and less than, equal to, or greater than 11 h, 12, 13, 14, 15, 16, 17, 18, or 19 h.

Carbonizing the solid can include heating at any suitable temperature to carbonize the carbon starting material and to form the carbon material precursor. Carbonizing the solid can include heating the solid at a temperature of 600° C. to 1000° C., or 700° C. to 900° C., or less than or equal to 1000° C. and greater than or equal to 600° C. and less than, equal to, or greater than 620, 640, 660, 680, 700, 710, 720, 730, 740, 750, 760, 770, 780, 790, 800, 810, 820, 830, 840, 850, 860, 870, 880, 890, 900, 920, 940, 960, or 980° C. The carbonizing of the solid can be performed under an inert gas, such as argon, nitrogen, or a combination thereof. The carbonizing of the solid can include heating the solid for any suitable duration, such as a duration of 10 min to 20 h, or less than or equal to 20 h and greater than or equal to 10 min and less than, equal to, or greater than 20 min, 30, 40, 50 min, 1 h, 2, 3, 4, 5, 6, 8, 10, 12, 14, 16, or 18 h.

The removing can be performed in any suitable way and can depend on the type of removable material used. For example, the removing can include etching, heating, or a combination thereof. The etching can include etching with acid (e.g., HF) or etching with base (e.g., sodium hydroxide or potassium hydroxide).

The oxidation state of the metal M can be retained during the method of making the carbon material. For example, an oxidation state of metal M prior to the chelation can be the same as the oxidation state of metal M in the carbon material. The coordination number of metal M can be retained during the method of making the carbon material. For example, a coordination state of metal M prior to the chelation can be the same as the coordination number of metal M in the carbon material.

### EXAMPLES

Various aspects of the present invention can be better understood by reference to the following Examples which are offered by way of illustration. The present invention is not limited to the Examples given herein.

Chemicals: Iron(III) acetylacetonate (99.5%, trace metal), cobalt(II) acetylacetonate (99%), nickel(II) acetylacetonate (95%), copper(II) acetylacetonate (99.9%, trace metal), ruthenium(III) acetylacetonate (97%), platinum(II) acetylacetonate (99.8%, trace metal), palladium(II) acetylacetonate (98%), carbon tetrachloride (99.9%), ethylenediamine (99.5%), tetraethyl orthosilicate (TEOS, 98%), and pluronic P123 (Mn-5,800) were purchased from Sigma-Aldrich. Hydrofluoric acid (TraceMetal grade), hydrochloric acid (TraceMetal grade), and nitric acid (TraceMetal grade) were purchased from Fisher Chemical. N-Methyl-2-pyrrolidone (NMP) was purchased from Fisher Scientific. Platinum wire (0.5 mm diameter, Premion®, 99.997%) and Toray Carbon Paper (TGP-H-60) were from Alfa Aesar. Polyvinylidene fluoride (PVDF) was from MTI corporation. All chemicals were used as received.

Synthesis of SBA-15. 6 g Pluronic P123 was firstly dissolved in 180 mL 2M hydrochloric solution at 40° C. with the help of stirring (500 rpm) in a 500 mL sealed polypropylene bottle. After being dissolved, 12.75 g of TEOS was added, and the solution was kept stirring for 20 h. The composition of the achieved gel was: 1 TEOS: 0.017 P123: 5.68 HCl: 197 H₂O. After 20 h, the whole bottle was kept in oven at 100° C. for 24 h under static condition. The white precipitant was recovered by Büchner filtration, washed with ultrahigh purity water/methanol 1:1 volume ratio twice, and it was kept in the hood for three days for air dry. The obtained solid was heated to 550° C. under air at a heating rate of 2° C. min⁻¹ and calcined for 5 h.

Synthesis M-NACs. The corresponding metal acetylacetonate was firstly added into the solution of ethylenediamine (1.80 g) and carbon tetrachloride (4.00 g), followed by adding SBA-15 (0.80 g). Caution: the metal precursor may catalyze the condensation of carbon tetrachloride and ethylenediamine with the release of HCl gas. The mixture was then heated in an oil bath at 90° C. for 16 h for condensation before the oil bath temperature increased to 120° C. for 4 h to remove the uncondensed ethylenediamine and carbon tetrachloride. The obtained powders were calcined under Ar flow, with temperature raised at a ramping rate of 3° C. min⁻¹ and further maintained at 800° C. for 2 h. The achieved black powder was then etched with 5 wt % HF solution to remove the SBA-15. The catalyst was recovered via centrifuge, washed with deionized water until the pH reached 7. The catalyst was further dried at 100° C. for future usage.

Characterization. Aberration corrected HAADF STEM imaging was performed using a probe-corrected Thermo Fisher (FEI) Titan Themis. Powder X-ray diffraction (XRD) was carried out on a Bruker D8A25 diffractometer with Cu Kα radiation (λ=1.54184 Å). N₂ physisorption was performed using an auto-adsorption analyzer (Micromeritics, 3Flex) at −196° C. Elementary analysis was conducted using a Perkin Elmer 2100 Series II CHN/S Analyzer. Inductively coupled plasma mass spectroscopy (ICP-MS) for metal loadings was performed using a Thermo Fisher Scientific X Series 2 spectrometer. X-ray photoelectron spectrometry (XPS) was recorded on a PerkinElmer PHI ESCA system with Physical Electronics (PHI). X-ray absorption spectroscopy (XAS) characterizations of the Ni, Cu, Ru, Pt-NAC catalysts were measured at Beamline 9-BM of the Advanced Photon Source in Argonne National Laboratory. X-ray fluorescence from the NAC catalysts was collected using Lytle detector or 13-element Ge solid state detector. For each element, the corresponding reference metal foil was measured simultaneously in transmission mode. The Athena and Artemis programs of the Demeter package were used for EXAFS data processing and analysis. λ(k) spectra representing the EXAFS oscillation were extracted by the embedded background removal method and then analyzed using the EXAFS equation. The first coordination shell after Fourier Transform was fitted using up to two single scattering paths (2 M-N paths or 1 M-N and 1 M-O) based on chemical information derived from XPS. The overall coordination number of the metal absorber was fixed at 4, and a common reduction factor S₀² and absorption edge correction dE₀ were used for two-shell fitting.

Electrode Preparation. 40 mg of the dried catalyst powder was ground with 4 mg polyvinylidene fluoride (PVDF) (industrial adhesive) with a few drops of 1-methyl-2-pyrrolidone (MP) (solvent) to produce catalyst paste that was painted directly onto a 1.0 cm×2.0 cm carbon paper (Toray TGP-H-060). The catalyst-decorated carbon paper was dried in a vacuum oven overnight and served as a working electrode. The deionized water was obtained from a Millipore Autopure System.

Electrochemical CO₂RR Test. Autolab electrochemical workstation was used to conduct CO₂ reduction experiments in aqueous 0.5 M KHCO₃. A platinum wire was used as counter electrode. All potentials were measured against an Ag/AgCl reference electrode (4.0 M KCl, Pine instrument) and were converted to those against a reversible hydrogen electrode (RHE). The experiments were performed in a gas-tight cell with two compartments separated by an anion exchange membrane (Nafion® 212). Each compartment contained 12 mL electrolyte with approximately 10 mL headspace.

Product Analysis. Before the experiment, the electrolyte in the cathode compartment was saturated with CO₂ by bubbling CO₂ gas for at least 30 min and was stirred at 900 rpm. CO₂ gas was delivered at an average rate of 10 mL/min (at room temperature and ambient pressure) and routed directly into the gas sampling loop of a gas chromatograph (SHIMADZU GC-2014). The gas phase composition was analyzed by GC every 35 min. The GC analysis was set up to split the gas sample into two aliquots whereof one aliquot was equipped with a thermal conductivity detector (TCD) for H₂ quantification. The second aliquot was equipped with a methanizer and a flame ionization detector (FID) for analyzing CO and C1 to C3 hydrocarbons. Argon (Corp Brother, 99.9999%) and hydrogen gas (Corp Brother, 99.9999%) were employed as carrier or make-up gases, respectively. ¹H NMR method was employed at the end of experiments to characterize liquid products. To be specific, 700 μL aliquot of the electrolyte was mixed with 70 μL dimethyl sulfoxide (DMSO) standard solution (20 mM DMSO in D₂O). ¹H NMR spectra were recorded on Varian NMRS 600 MHz.

### Example 1. Synthesis and Characterization of Catalysts

To synthesize the catalysts, ethylenediamine is used as a strong chelating ligand to stabilize both base and precious metal atoms. Moreover, ethylenediamine acts an ideal N source for the carbon materials and its high N/C ratio in ethylenediamine ensures the high N content in the final catalyst even after pyrolysis, which is successfully demonstrated in our previous work in the synthesis of nitrogen assembly carbons (NACs). We use the Ni-NAC as an example to demonstrate this general coordination-condensation strategy. Ni^{II} acetylacetonate was firstly dispersed in the ethylenediamine, followed by the slow addition of carbon tetrachloride. A mesoporous silica template (SBA-15) was then added for the further condensation reaction to proceed in the mesopores. After 16 h at 90° C., the solid-liquid mixture completely solidifies into a brown mixture. The obtained polymer was then carbonized at 800° C. under Ar while the Ni^{II} ions, together with their coordination spheres, were integrated into the graphitic domain of the NAC support as isolated metal sites. After removing the silica template by etching, the Ni-NAC catalyst can thus be isolated. More importantly, this general strategy can be readily applied to synthesize other metal(M)-NACs (including Fe^{III}, Co^{II}, Cu^{II}, Ru^{II}, Rh^{II}, Pd^{II}, and Pt^{II}) from the corresponding acetylacetonates.

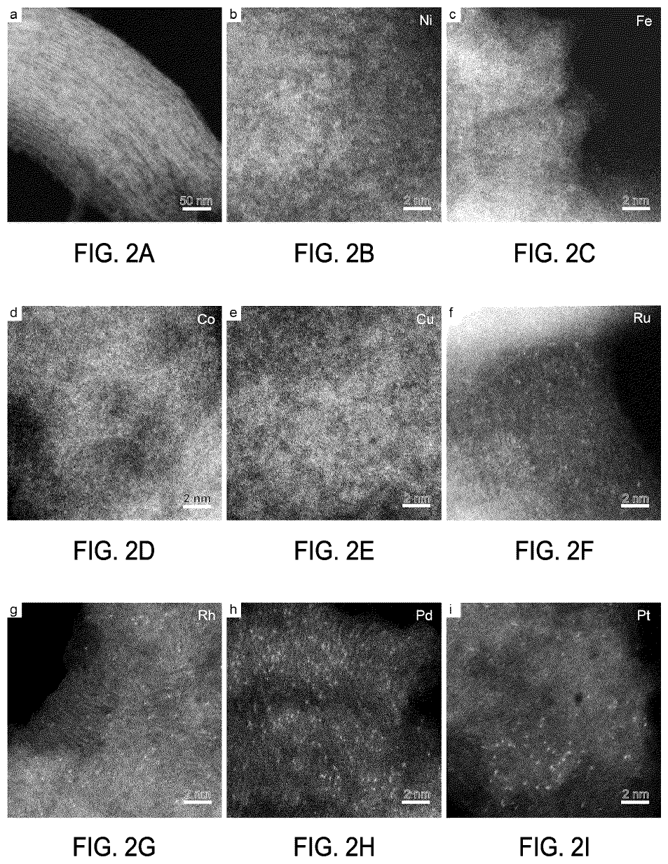

All M-NACs exhibit the rod-shaped morphology (FIG. 2A) with aligned and well-ordered mesopores and high surface areas, owing to the use of the ordered mesoporous silica template. N₂ physisorption results show type IV isotherm for all samples, characteristic of ordered mesoporous materials. The surface areas are calculated to be 720-930 m² g⁻¹, and pore diameters are 3.4-5.5 nm. The high monodispersity of the mesopores, long-range ordering, and high surface areas are unique features of these M-NACs, when compared to other reported catalysts for CO₂RR.

FIG. 2A is a high-angle-annular-dark-field (HAADF) scanning transmission electron microscopy (STEM) image that shows the ordered mesoporous structure of Ni-NAC at low magnification. Single metallic atoms are directly revealed as bright dots dispersed on the NAC support without any noticeable presence of nanoparticles in aberration-corrected STEM images (FIGS. 2B-2I). The powder X-ray diffraction patterns of M-NACs showed no signals of metal nanoparticles. The two broad diffraction peaks, centered at ca. 250 and 44°, correspond to the (002) and (100) planes of the NAC matrix, agreeing with STEM images (FIGS. 2B-2I). Elemental analysis shows the metal loading for base metal-NACs to be Fe (0.7 wt %), Ni (1.7 wt %), Co (1.6 wt %), and Cu (4.2 wt %), respectively. X-ray photoelectron spectra (XPS) of the M-NAC catalysts showed only signals for carbon, nitrogen, oxygen, and corresponding metals. The Fe2p, Co2p, Ni2p, Cu2p, Pd3d, and Pt4f XPS spectra for the M-NACs showed that the binding energies of these metals correspond to Fe^{III}, Co^{II}, Ni^{II}, Cu^{II}, Pd^{II}, and Pt^{II} species, respectively, for the corresponding catalysts, with the same oxidation state as the starting metal precursor.

XPS and CHN elemental analysis (Table 1) both demonstrate that the M-NACs are mainly composed of carbon (81.3-86.7 at %) and nitrogen (8.1-11.7 at %) with the C:N ratio at the range of 7.0 to 10.7, indicating the uniform distribution of nitrogen on the surface and bulk of the M-NACs. The N1s spectra for the M-NACs was deconvoluted into five peaks, corresponding to the pyridinic N, metal-N, pyrrolic N, graphitic N, and pyridinic N-oxide, respectively. These surface-rich N atoms provide additional binding sites to increase surface concentration of CO₂. The non-innocent surface of carbon support is populated with graphitic nitrogen assembly. These nitrogen assembly sites, composed of closely-spaced graphitic nitrogens rather than isolated ones, can modify the electronic density of the metal centers and serve as co-catalyst in multi-step electric processes when multiple binding sites are demanded.

TABLE 1
XPS and CHN elemental analysis of M—NACs.

| | | | XPS | | CHN | | | ICP |
|---|---|---|---|---|---|---|---|---|
| | | C(at | N(at | C:N | C(at | N(at | C:N | metal |
| | samples | %) | %) | (atomic) | %) | %) | (atomic) | (wt %) |
| 1 | Fe—NAC | 81.0 | 11.7 | 6.9 | 66.60 | 12.15 | 6.4 | 0.7 |
| 2 | Co—NAC | 81.9 | 10.9 | 7.5 | 63.58 | 12.43 | 6.0 | 1.6 |
| 3 | Ni—NAC | 84.6 | 9.4 | 9.0 | 65.21 | 11.17 | 6.8 | 1.7 |
| 4 | Cu—NAC | 84.4 | 11.4 | 7.4 | 64.79 | 11.77 | 6.4 | 4.2 |
| 5 | Ru—NAC | 86.7 | 9.2 | 9.6 | 70.91 | 12.17 | 6.8 | 0.2 |
| 6 | Rh—NAC | 82.1 | 11.8 | 7.0 | 73.27 | 12.22 | 7.0 | 0.1* |
| 7 | Pd—NAC | 79.7 | 8.8 | 9.1 | 70.28 | 12.46 | 6.6 | 0.5 |
| 8 | Pt—NAC | 83.1 | 11.0 | 7.6 | 73.30 | 12.32 | 6.9 | 1.0 |

### Example 2. Structural Identification of the Active Sites

Extended X-ray absorption fine structure (EXAFS) is a powerful tool for probing the coordination environment of metal atoms. The Fourier transform of the EXAFS oscillation gave peaks corresponding to various coordination shells around the metal center, which was the R-space plot. R-space plots of metal K-edge EXAFS of Ni-NAC and Ru-NAC were compared with those of the corresponding metal foil and metal oxide reference standards after Fourier transform of k³-weighted χ(k) of the same k range. For all M-NACs, only a single main peak before 2 Å was observed in R-space plot, indicating the existence of only light scatters around the single-atom metal site, rather than metal-metal scattering path as in the corresponding metal foils or higher scattering path such as M-O-M in metal oxides. Quantitatively, the least-square peak fitting analysis of the EXAFS showed that all M-NACs have MX4 moiety with univariate or bivariate M-X bond length except Ru and Fe. X can be C, N, or 0, which are challenging to distinguish. For example, the EXAFS of Ni-NAC could be fitted with two Ni—N paths with bond lengths of (1.87±0.01) and (2.05±0.02) Å, which are very close to the Ni—N bond distance in molecular Ni^{II} phthalocyanine or porphyrin complex (1.90 Å) and amine-coordinated Ni complex. The use of three single scattering paths of Ni—N1, Ni—N2, and Ni—C can also give reasonable fitting results. Similarly, for Cu-NAC, a good EXAFS fitting could be achieved by using either one path of Cu—N, or two paths of Cu—N(degeneracy is 3) and Cu—C. For Fe^{III}- and Ru^{III}-NAC, an additional M-X scattering path was included for accurate curve fittings. Considering the oxidation state of Ru or Fe is +3, the fifth coordination is likely to balance the charge at the Ru center with a mono-anionic ligand; therefore, the most likely extra path is hydroxide (OH⁻) in an axial geometry. It is important to note that our new synthetic method is likely to retain the oxidation state of the metal precursors, which is the key to synthesizing the desired catalysts on demand.

The X-ray absorption near edge structure (XANES) region can reflect the chemical state of the metal center and is sensitive to the 3-dimensional arrangement of scatters around. From the comparison of XANES spectra, the valence of Cu in Cu-NAC is very close to that of CuO, while Co, Ni, and Pt in M-NACs are in between that of metallic foil and highest valence oxide. Judging from the position and intensity of the main peak in the K-edge that stems from is to 4p transition, Fe-NAC has a valence state close to Fe₂O₃. Similarly, the valence of Ru in Ru-NAC is a little lower than that of RuO₂. These are in accordance with XPS analysis. For the Fe-, Co-, Ni-, and Cu-NACs' K-edge XANES spectra, the shoulder peak in the middle of the K-edge is ascribed to is-4p shakedown excitation, which is much weaker than that of a square planar species with D₄ₕ symmetry, indicating the distortion of or deviation from the planar structure. The XANES spectra of various MN₄Cₓ (Fe- and Ru—O₁N₄Cₓ) structures with bonding metrics according to EXAFS analysis were calculated using FEFF8 program and compared with the experimental data. The main features of experimental XANES can be well reproduced by non-planar or distorted planar MN₄ moieties. Notably, for Ni-NAC, Cu-NAC, and Pt-NAC, we found that a metal center of MN₃C₁ gives better simulations of the XANES features than MN₄. Besides, XANES simulation corroborates the existence of M-O bond at the metal center of Fe-NAC and Ru-NAC.

### Example 3. Electrocatalytic CO₂RR Over M-NACs

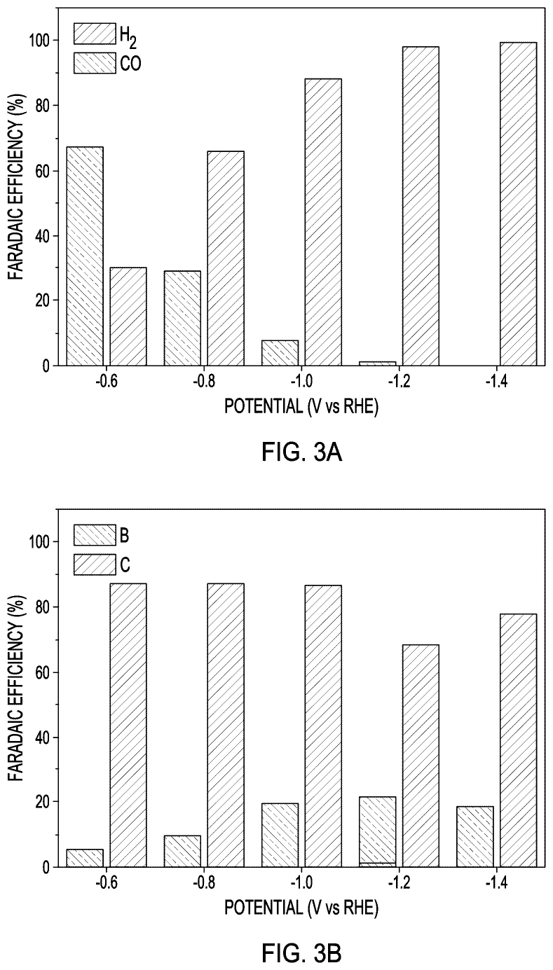

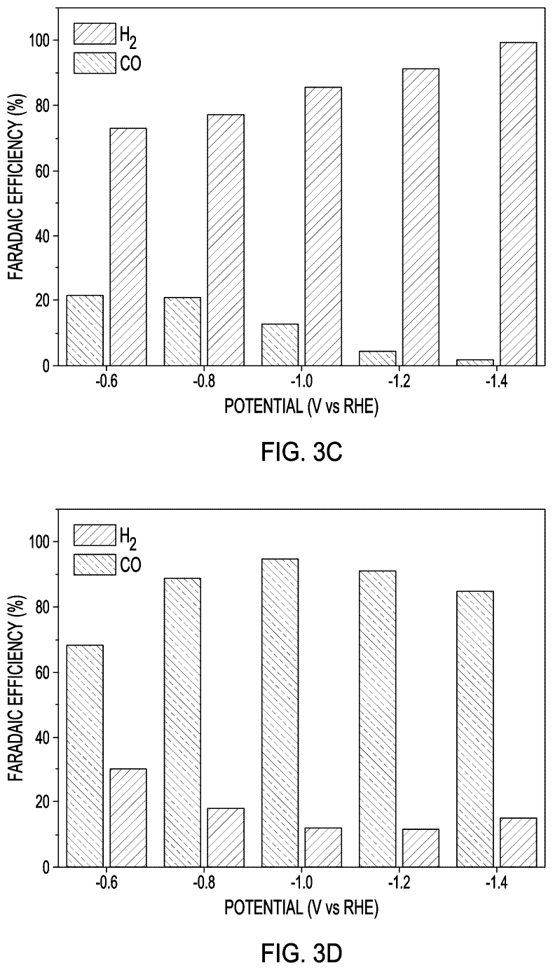

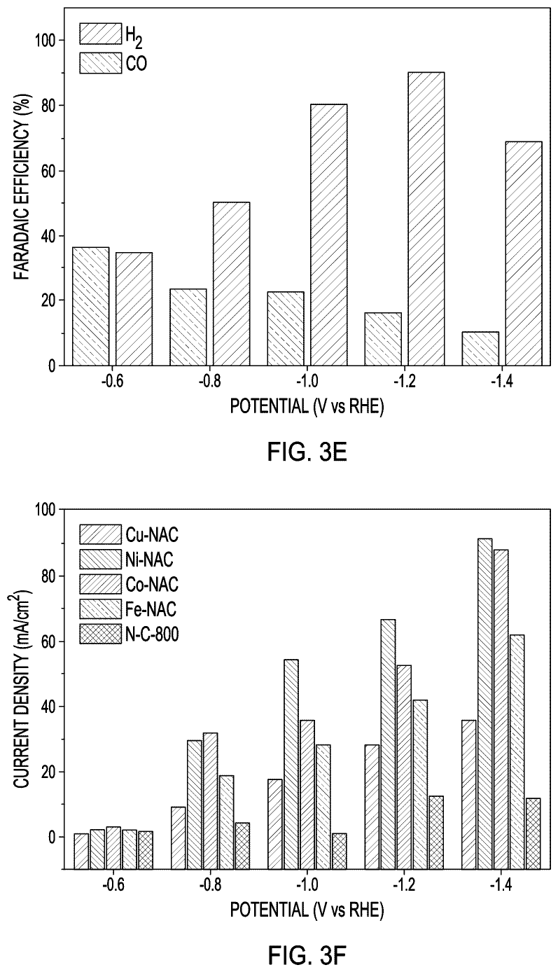

The NAC support provides a highly versatile platform to accommodate different single atom metal sites, based on which we tested their electrocatalytic properties for CO₂RR. Base metals are more abundant than precious metals, so we began with Fe, Cu, Co, and Ni single atom catalysts. Before each test, we ran cyclic voltammetry (CV) in both Ar-saturated and CO₂-saturated KHCO₃ solutions. There were no metal redox peaks during CV scans in either Ar or CO₂, which is in line with our expectation that metal atoms are stabilized in the NACs and cannot be easily reduced or oxidized. From the CVs, the currents start to increase at about −0.6 V vs. reversible hydrogen electrode (RHE), suggesting CO₂RR and hydrogen evolution reaction (HER) happens at this potential. Thus, we choose −0.6 V to −1.4 V vs. RHE as our potential range. Fe-NAC single-atom catalyst generates either more CO (at −0.6 V) or more H₂ (<−0.8 V) (FIG. 3A). The potential-dependent CO/H₂ selectivity of Fe-NAC makes it a good candidate for syngas generation. Cu materials are known to be active for the production of high-value carbon products, such as ethylene and ethanol. However, the Cu-NAC single-atom catalyst, as shown in FIG. 3B, generates a mixture of CO and H₂. As the applied potential decreased from −0.6 V to −1.2 V vs. RHE, CO FE increased from 5.3% to 21.1%, and there were no other carbon products detected. The FE of CO generation with Co-NAC catalyst is similar to Cu-NAC catalyst, which reaches 21.3% at −0.6 V (FIG. 3C) but starts to decrease with more negative potentials. Among all the base metal single-atom catalysts prepared, Ni-NAC is the most promising and generates 95% CO at −1.0 V (FIG. 3D), with no liquid products observed. In addition, the CO FE with Ni-NAC remains high (>85%) at a wide potential range from −0.8 V to −1.4 V. We also synthesized a metal-free catalyst calcined at 800° C. (NAC-800) as a control. As shown in FIG. 3E, The CO selectivity of NAC-800 catalyst is clearly lower than Ni-NAC and Fe-NAC, suggesting that N-doped site itself is not the dominant reaction site for CO generation. Additionally, HER keeps increasing as the potential decreases, suggesting that NAC-800 could not work in high overpotential conditions.

The current densities of all these catalysts were carefully monitored. As shown in FIG. 3F, Ni-NAC shows the highest current density at nearly every tested potential from −0.6 V to −1.4 V, while NAC-800 has the lowest current density. Specifically, with Ni-NAC as the catalyst for CO₂ reduction at −1.4 V, the CO FE is higher than 85%, and the current density reaches 91 mA/cm². The current density of Fe-NAC, Cu-NAC, and Co-NAC is lower than Ni-NAC but higher than NAC-800. However, the selectivity towards CO formation is much worse than Ni-NAC.

With regard to precious metals, HER is dominating under every potential with all the noble metal catalysts, and only Rh-NAC and Pd-NAC could generate moderate CO (<10% for Rh-NAC and 25% for Pd-NAC). The CV spectrum of Pt-NAC also shows that the current starts to increase before −0.6 V, which is attributed to the HER.

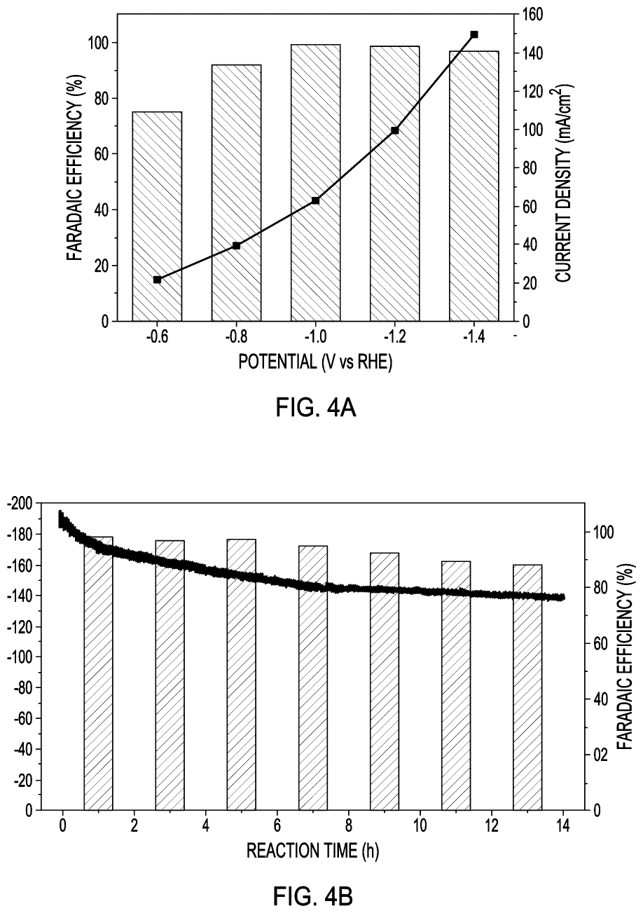

The CO₂ reduction results in H-cell suggest that Ni-NAC is the best single-atom candidate for CO₂RR. To further enhance the CO₂RR activity of Ni-NAC, a gas-diffusion cell is applied. With gas-diffusion cell to further improve the CO₂ mass transfer, both current density and FE have improved, agreeing with our expectation. The CO FE starts from 75% at −0.6 V and keeps higher than 90% from −0.8 V to −1.4 V (FIG. 4A). Compared with the current density in H-cell of less than 100 mA/cm², the current density with flow cell increases to 151 mA/cm². The Ni-NAC possesses not only high CO selectivity and current density but also high robustness during CO₂RR. To the best of our knowledge, our Ni-NAC catalyst is among the high-performance Ni single atom catalysts (Table 2). Electrolysis with Ni-NAC electrode was performed under −1.4 V in a flow cell for 14 hours. The current density dropped slightly from 190 to 142 mA/cm² after 14 hours, and the CO FE remained around 90% (FIG. 4B).

TABLE 2
Ni single atom catalyst for electrochemical CO₂ reduction reaction.

| | | | | | Current | |
|---|---|---|---|---|---|---|
| | Atom | | Potential | Faradaic | density | |
| Ni | ratio | | (V vs | efficiency | (mA | Stability |
| catalysts | (%) | Products | RHE) | (%) | cm-2) | (h) |
| This work | 1.7 | CO | −0.8~−1.4 | >90 | 151 | 14 |
| | | | | | (−1.4 V) | |
| Ni—N—Gr | 2.2 | CO | −0.7 | >90 | <0.4 | 5 |
| Ni—N4 | 1.41 | CO | −0.81 | 99 | 28.6 | 30 |
| N-doped | 0.8 | CO | −0.68 | 92 | 30 | 20 |
| graphene | | | | | | |
| Ni(i)—N4 | 0.82 | CO | −0.5 | 97 | 22 | 100 |
| Unsaturated | 5.44 | CO | −0.63 | 98 | 71.5 | 12 |
| Ni—N | | | | | | |
| Ni single | 0.44 | CO | −0.65 | 95 | 50 | 20 |
| atom | | | | | | |
| Ni—N3—V | | CO | −0.9 | 90 | 65 | 14 |
| Ni—N | 2.6 | CO | −0.8 | 90.2 | 5 | 6 |
| Ni SA | 0.28 | CO | −1.0 | 97 | 49 | 24 |
| SA Ni | 1.3 | CO | −1.0 | 88 | 308 | 120 |
| decorated | | | | | | |
| carbon | | | | | | |

### Example 4. Theoretical Investigation

The CO₂RR activity on each CO-producing metal (Ni, Fe, Co, and Cu) was studied here with DFT calculations. Normally, CO₂ reduction toward CO requires two proton-electron transfers in a concerted mechanism. The first transfer of a combined proton and electron to CO₂ produces the COOH intermediates, which is consequently converted into an adsorbed CO through the second proton-electron transfer. From an analysis of the CO₂RR free energy profile (through which the potential-limiting step can be identified), and of calculated structures, from the top and side point of view, for intermediates formed with CO₂, COOH, and CO, formation of the COOH intermediate limits the rate on Ni and Cu on N₄-doped graphene (NiN₄ and CuN₄). While on FeN₄ and CoN₄, the reduction of CO₂ is limited by CO desorption with an energy cost of 1.3 and 0.6 eV, respectively.

The activity is very sensitive to the local coordination of the single metal. Here we show the single metal atom could also bind with both carbon and nitrogen (NₓC₄₋ₓ) instead of four nitrogen neighbors. Since the characterization techniques such as EXAFS cannot distinguish neighboring carbon and nitrogen unambiguously, we investigate the CO₂RR performance of Ni single atom in a configuration of N₄, N₃C₁, N₂C₂, and N₁C₃, and find that when coordinating with more C atoms, the intermediate species, COOH and CO, bind stronger to the active site. The metal N₃C₁ structure has the highest activity with the lowest energy cost for the potential-limiting step. Furthermore, we show that, on NiN₃ and CuN₃, the COOH species could be further stabilized on the neighboring carbon rather than the metal, reducing the energy cost of first proton transfer to 0.8 and 0.9 eV on Ni and Cu, respectively. The carbon in the first coordination shell thus not only modifies the electronic property of the metal but also provides an additional site for the adsorption of reaction intermediates. CO desorption remains to limit the reaction kinetics over FeN₃ and CoN₃ due to its strong adsorption. The possible MN₃C coordination structures of Ni and Cu are supported by the XANES simulation. Our calculations thus provide an explanation for the experimental observation that Ni single atoms are the most active among the tested base metals.

Results of HER calculations showed Fe and Co in both N₄ and N₃ configurations can catalyze HER efficiently, which agrees with the product distribution in FIGS. 3A and 3C. The HER activity over CuN₄ should be much lower, due to the weak adsorption of hydrogen, than it on CuN₃C; the dominant selectivity to H₂ over Cu samples in experiments indicates that the CuN₃C configuration is more likely, in agreement with the XANES simulation.

### Example 5. Hard-Templated Methodology for Synthesis of Ni-NACs

To regulate mass diffusion within the carbon matrix, the synthesis of Ni-NAC was performed via a hard-templated methodology, using three different silica-based templates that are SBA-15, KIT-6, and MCM-48, encompassing the polymerization of ethylenediamine and carbon tetrachloride along with Ni(II) acetylacetonate inside the mesopores of the hard templates. This versatility in template selection is useful, as it allows for producing NACs with distinct microscopic structures and mesoporous configurations. The pre-coordination enables the pre-regulation of the Ni center with desirable coordination configuration. The implementation of this template is pivotal for achieving regulated polymerization, thereby influencing the morphology of the resulting Ni-NAC. Following polymerization, the material was carbonized at elevated temperatures under an inert atmosphere, a critical process for the incorporation of nickel ions into the graphitic domain of the NAC support. The subsequent etching of the silica template facilitated the release of the three Ni-NAC catalysts: Ni-NAC(SBA-15), Ni-NAC(KIT-6), and Ni-NAC(MCM-48). This modular approach in the synthesis of Ni-NACs grants substantial control over various catalyst properties.

Experimental for forming Ni-NACs of Example 5: To a 50 mL round bottom flask, 1.8 g of ethylenediamine was introduced, followed by the addition of 100 mg of nickel acetylacetonate. The mixture was stirred for 5 minutes before 4.0 g of carbon tetrachloride was added and stirring continued for an additional 5 minutes. Subsequently, 0.8 g of silica template (SBA-15, KIT-6, or MCM-48) was introduced, and the mixture was refluxed at 90° C. for 16 hours. After refluxing, the mixture was dried at 120° C. to evaporate any remaining carbon tetrachloride and ethylenediamine. The resultant residue was then calcined under an Ar atmosphere at 800° C. for 2 hours, with a ramping rate of 3° C./min. The black powder obtained was dispersed in a solution of 5 wt. % HF and 10 wt. % HCl (35 mL) and stirred for 24 hours. Centrifugation was employed to collect the catalyst, which was then washed several times with deionized water until a neutral pH was achieved. Finally, the black powder was dried at 100° C. overnight and stored for future use.

Synthesis of MCM-48 silica: In a 500 mL round bottom flask, octyltrimethylammonium bromide (0.67825 g) and F-127 surfactant (2.538 g) were dissolved in a mixture of ethanol (43 g), de-ionized water (129.8 g), and NH₃—H₂O (12.24 g, 30-33% NH₃ in H₂O). The mixture was stirred vigorously at 850 rpm until fully dissolved. Subsequently, 1.8 g of tetraethyl orthosilicate was quickly added to the flask while keep stirring continuously for approximately 1.5 minutes. The reaction mixture was left undisturbed at room temperature for 24 hours. The MCM-48 solid powder was collected via centrifugation at 8000 rpm for 10 min. The solid powder was washed with ethanol (3×35 mL) and dried under vacuum at room temperature overnight.

Synthesis of KIT-6 silica: Surfactant Pluronic P123 (4.0 g) was dissolved in a mixture of 144 mL of de-ionized water and 7.9 mL of 35 wt. % hydrochloric acid. After complete dissolution, 4.0 mL of n-butanol was added. This mixture was then stirred vigorously for 1 hour at 35° C. Then 8.6 mL of tetraethyl orthosilicate was added while the solution was stirred continuously for the subsequent 24 hours. Upon hydrothermal treatment at 100° C. for 24 hours, the resultant solid was filtered and dried at 80° C. The solid was then rinsed with de-ionized water to wash off the residual surfactant. The final step involved calcining the solid at 550° C. for 6 hours.

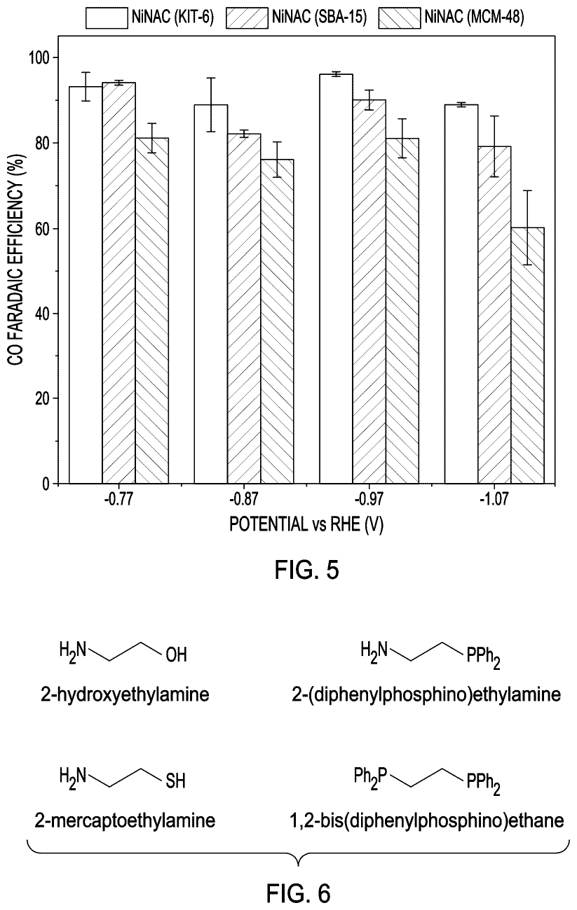

FIG. 5 illustrates electrochemical CO₂ reduction performance of the Ni-NACs synthesized using various hard templates. Ni-NAC(KIT-6) demonstrated ECO₂RR activity comparable to that of Ni-NAC(SBA-15). However, the performance of Ni-NAC(MCM-48) was notably inferior. This diminished efficacy in ECO₂RR can likely be attributed to inadequate CO₂ mass transport, a consequence of the reduced pore size and volume in Ni-NAC(MCM-48), thereby underscoring the critical role of catalyst microstructure on ECO₂RR performance.

### Example 6. Heteroatom-Doped Ni-SACs

To modulate the binding affinity of intermediates on the Ni center, the heteroatom-doped Ni-SACs with SBA-15 as the hard template were achieved by replacing ethylenediamine with O, S, P substituted ethylenediamine (FIG. 6), specifically 2-hydroxyethylamine, 2-mercaptoethylamine, 2-(diphenylphosphino)ethylamine, and 1,2-bis(diphenylphosphino)ethane. This approach takes advantage of the strong coordination of metal cations with 2-heteroatom substituted ethylamine (the nitrogen source), allowing metal sites to remain isolated prior to pyrolysis. The rich coordination chemistry involving oxygen (O), sulfur (S), and phosphorus (P) with Ni facilitates a modular synthesis approach, resulting in the creation of five distinct types of heteroatom-doped NiNACs. These include the original NiN4-NAC (NiNAC(SBA-15)), which features coordination of up to four nitrogen atoms, NiN3S1-NAC where one nitrogen is replaced by sulfur, NiN301-NAC with one nitrogen replaced by oxygen, and NiN3P1-NAC or NiN2P2-NAC, where one or two nitrogens are substituted by one or two phosphorus atoms, respectively.

Experimental for forming Ni-NACs of Example 6: In a 50 mL round bottom flask, 4.0 g of carbon tetrachloride was added, followed by the addition of 100 mg (0.39 mmol) of nickel acetylacetonate. The mixture was stirred for 3 minutes, after which an equivalent amount of ethylenediamine (0.39 mmol, 1.0 eq.) and a choice of heteroatom source (either 2-hydroxyethylamine, 2-mercaptoethylamine, 2-(diphenylphosphino)ethylamine, or 1,2-bis(diphenylphosphino)ethane) (0.39 mmol, 1.0 eq. each) were added. The reaction was then stirred for an additional 10 minutes. Following this, 0.8 g of SBA-15 and then 1.8 g of ethylenediamine were introduced sequentially into the solution, and the mixture was refluxed at 90° C. for 16 hours. The residue was further dried at 120° C. to remove any unreacted carbon tetrachloride and ethylenediamine. This resulting solid was calcined under an Ar atmosphere at 800° C. for 2 hours, with a temperature ramping rate of 3° C./min. The obtained black powder was then dispersed in a mixed acid solution (35 mL of 5 wt. % HF and 10 wt. % HCl) and stirred for 24 hours. The catalyst was recovered by centrifugation and washed with deionized water several times until the water reached a neutral pH. Finally, the black powder was dried at 100° C. overnight and stored for future use.

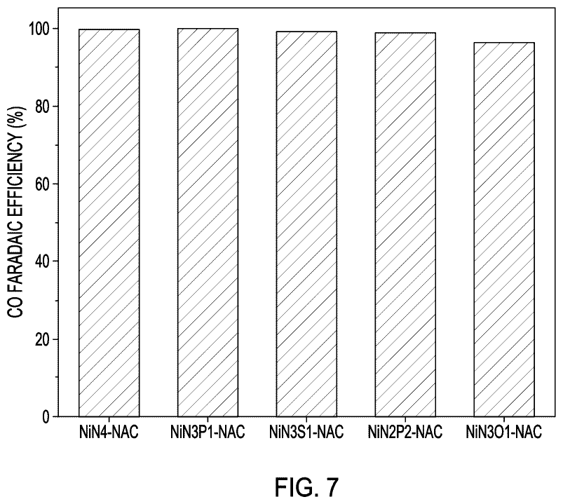

FIG. 7 illustrates electrochemical CO₂ reduction performance of the various heteroatom-doped Ni-NAC catalysts (SBA-15) at potentials of −0.84 V vs. RHE. All heteroatom-doped NiNAC variants exhibited high efficiency in CO production, which demonstrates the robustness of the current Ni-NAC synthesis methodology.

Experimental for electrode preparation and electrochemical measurements for Examples 5 and 6. Electrode preparation: 10 mg of Ni-NAC catalyst, 2 ml of 2-propanol, and 20 L of Nafion binder solution (5 wt %) were mixed and sonicated for 60 min to obtain a homogeneous ink. The prepared catalyst ink was air-brushed onto a 3×3 cm² Sigracet 28 BC gas diffusion layer electrodes to cover an area of 1×1 cm². The electrodes were dried in air overnight before use. Electrochemical measurements: The electrochemical measurements were run with a BioLogic VSP300 workstation. The electrolysis experiments were performed in a three-component flow cell. A pre-calibrated leak-free Ag/AgCl reference electrode was used as the reference electrode. The Ni-NAC cathode was affixed on a fluorine rubber gasket (with Cu tape on four sides) with a window of 1×1 cm² to define the electrode active area. A Ni form anode with an active area of 2×2 cm² was used as the counter electrode. On the cathode side, the gas flow chamber supplied 30 sccm CO₂ by a mass flow controller while the anode was open to the atmosphere. The cathodic and anodic chambers were separated by an anion exchange membrane, and 30 mL of 0.5 M KHCO₃ catholyte was flowed through the cathodic chamber and circulated by a peristaltic pump at a flow rate of 5 mL/min. A 30 mL portion of 0.5 M KHCO₃ or 1 M KOH anolyte was flowed through the anodic chamber and circulated by the peristaltic pump. All potentials were recorded against the Ag/AgCl reference electrode and converted to vs reversible hydrogen electrode (RHE) with internal resistance compensations: E_{vs. RHE}=E_{vs. Ag/AgCl}+0.0591×pH+0.197−i×Rᵢ, where i is the average current during electrolysis and Rᵢ is the solution resistance between the working and reference electrodes. The gaseous products were quantified by online gas chromatography (SRI MG-5). The Faradaic efficiencies (FEs) were calculated using the following equation:

$${FE}_{x} ( \% ) = \frac{{Q}_{x}}{{Q}_{tot}} \times 100 \% = \frac{{n}_{x} \times {C}_{x} \times vt \times F}{I \times t \times {V}_{M}} = \frac{{n}_{x} \times {C}_{x} \times v \times F}{I \times {V}_{M}}$$

wherein FEₓ is Faradaic efficiency for the gas product x; Qₓ is charge transferred for product x formation; Qₜₒₜ is charge passed through the working electrode; nₓ is electrons transferred for reduction to product x; Cₓ is volume fraction of the product x detected by GC; V is outlet gas flowrate; t is CO₂ electrolysis time; F is Faradaic constant, 96485 C·mol⁻¹; I is total applied current during CO₂ electrolysis; and V_{M} is molar volume at 1 atm and 25° C., 24.4 L·mol⁻¹.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects.

The following exemplary aspects are provided, the numbering of which is not to be construed as designating levels of importance:

Aspect 1 provides a carbon material comprising:
a mesoporous carbon matrix comprising a metal M, wherein M is bonded directly to the carbon matrix, M is bonded directly to an atom A that is bonded directly to the carbon matrix, or a combination thereof, wherein at each occurrence A is independently chosen from N, O, P, S, and B.

Aspect 2 provides the carbon material of Aspect 1, wherein A is O.

Aspect 3 provides the carbon material of any one of Aspects 1-2, wherein A is N.

Aspect 4 provides the carbon material of any one of Aspects 1-3, wherein A is S.

Aspect 5 provides the carbon material of any one of Aspects 1-4, wherein M has a coordination number of 4.

Aspect 6 provides the carbon material of any one of Aspects 1-5, wherein M has a coordination number of 3.

Aspect 7 provides the carbon material of any one of Aspects 1-6, wherein M is bonded to the carbon matrix as M-C^{M}₄, C^{M}₃-M-AC^{M}, C^{M}₂-M-(AC^{M})₂, C^{M}-M-(AC^{M})₃, M-(AC^{M})₄, M-C^{M}₃, C^{M}₂-M-AC^{M}, C^{M}-M-(AC^{M})₂, M-(AC^{M})₃, or a combination thereof, wherein at each occurrence C^{M} is independently chosen from a carbon atom of the carbon matrix.

Aspect 8 provides the carbon material of any one of Aspects 1-7, wherein M is bonded to the carbon matrix as C^{M}-M-(AC^{M})₃, wherein at each occurrence C^{M} is independently chosen from a carbon atom of the carbon matrix.

Aspect 9 provides the carbon material of any one of Aspects 1-8, wherein M is bonded to the carbon matrix as M-C^{M}₄, C^{M}₃-M-NC^{M}, C^{M}₂-M-(NC^{M})₂, C^{M}-M-(NC^{M})₃, M-(NC^{M}₄), M-C^{M}₃, C^{M}₂-M-NC^{M}, C^{M}-M-(NC^{M})₂, M-(NC^{M})³, or a combination thereof, wherein at each occurrence C^{M} is independently chosen from a carbon atom of the carbon matrix.

Aspect 10 provides the carbon material of any one of Aspects 1-9, wherein M is bonded to the carbon matrix as C^{M}-M-(NC^{M})₃, wherein at each occurrence C^{M} is independently chosen from a carbon atom of the carbon matrix.

Aspect 11 provides the carbon material of any one of Aspects 1-10, wherein the carbon material is substantially free of metal nanoparticles comprising metal M.

Aspect 12 provides the carbon material of any one of Aspects 1-11, wherein the carbon material further comprises metal nanoparticles comprising metal M.

Aspect 13 provides the carbon material of any one of Aspects 1-12, wherein the mesoporous carbon matrix comprises mesopores having a pore diameter of 1 nm to 50 nm.

Aspect 14 provides the carbon material of any one of Aspects 1-13, wherein the mesoporous carbon matrix comprises mesopores having a pore volume of 5 nm to 15 nm.

Aspect 15 provides the carbon material of any one of Aspects 1-14, wherein the carbon material has a surface area of 100 to 2500 m²/g.

Aspect 16 provides the carbon material of any one of Aspects 1-15, wherein the carbon material has a surface area of 600 to 950 m²/g.

Aspect 17 provides the carbon material of any one of Aspects 1-16, wherein M is 0.1 wt % to 40 wt % of the carbon matrix.

Aspect 18 provides the carbon material of any one of Aspects 1-17, wherein M is 0.1 wt % to 5 wt % of the carbon matrix.

Aspect 19 provides the carbon material of any one of Aspects 1-18, wherein M is a rare earth metal, a precious metal, or a transition metal.

Aspect 20 provides the carbon material of any one of Aspects 1-19, wherein M is a rare earth metal.

Aspect 21 provides the carbon material of any one of Aspects 1-20, wherein M is a precious metal.

Aspect 22 provides the carbon material of any one of Aspects 1-21, wherein M is a transition metal.

Aspect 23 provides the carbon material of any one of Aspects 1-22, wherein M is Zn, Al, Sn, Ga, In, Ge, Fe, Co, Ni, Cu, Pt, Pd, Ru, or Rh.

Aspect 24 provides the carbon material of any one of Aspects 1-23, wherein M is Fe^{III}, Fe^{II}, Co^{II}, Ni^{II}, Cu^{II}, Pd^{II}, or Pt^{II}.

Aspect 25 provides the carbon material of any one of Aspects 1-24, wherein M is Ni^{II}.

Aspect 26 provides the carbon material of any one of Aspects 1-25, wherein the mesoporous carbon matrix comprises nitrogen doping, phosphorus doping, oxygen doping, sulfur doping, or a combination thereof. For example, the mesoporous carbon matrix can comprise nitrogen doping.

Aspect 27 provides the carbon material of any one of Aspects 1-26, wherein the mesoporous carbon matrix comprises nitrogen atoms, phosphorus atoms, oxygen atoms, sulfur atoms, or a combination thereof, bonded thereto. For example, the mesoporous carbon matrix can comprise nitrogen atoms bonded thereto.

Aspect 28 provides the carbon material of Aspect 27, wherein the mesoporous carbon matrix comprises A atoms bonded between M and carbon atoms of the carbon matrix, A atoms bonded to the carbon matrix that are free of bonds to M, or a combination thereof.

Aspect 29 provides the carbon material of any one of Aspects 27-28, wherein the mesoporous carbon matrix comprises A atoms bonded between M and carbon atoms of the carbon matrix.

Aspect 30 provides the carbon material of any one of Aspects 1-29, wherein nitrogen, phosphorus, oxygen, sulfur, or a combination thereof is 0.1 wt % to 60 wt % of the carbon material. For example, nitrogen can be 0.1 wt % to 60 wt % of the carbon material.

Aspect 31 provides the carbon material of any one of Aspects 1-30, wherein nitrogen, phosphorus, oxygen, sulfur, or a combination thereof is 10 wt % to 15 wt % of the carbon material.

Aspect 32 provides the carbon material of any one of Aspects 1-31, wherein the mesoporous carbon matrix has a C:N, C:P, C:O, or C:S atomic ratio of 0.5 to 1000.

Aspect 33 provides the carbon material of any one of Aspects 1-32, wherein the mesoporous carbon matrix has a C:N, C:P, C:O, or C:S atomic ratio of 7 to 10.7.

Aspect 34 provides the carbon material of any one of Aspects 1-33, wherein carbon is 40 wt % to 99.9 wt % of the carbon material.

Aspect 35 provides the carbon material of any one of Aspects 1-34, wherein carbon is 65 wt % to 75 wt % of the carbon material.

Aspect 36 provides the carbon material of any one of Aspects 1-35, wherein the carbon material is a single-site heterogeneous catalyst.

Aspect 37 provides the carbon material of any one of Aspects 1-36, wherein the carbon material is a single-site heterogeneous catalyst that catalyzes electrochemical reduction.

Aspect 38 provides the carbon material of any one of Aspects 1-37, wherein the carbon material catalyzes electrochemical conversion of CO₂ to CO, of a mixture of a hydrogen source and CO₂ to CO and H₂, or a combination thereof.

Aspect 39 provides the carbon material of any one of Aspects 1-38, wherein the carbon material catalyzes electrochemical conversion of a gaseous composition comprising CO₂ to CO wherein the gaseous composition has a concentration of the CO₂ that is 1% to 100%.

Aspect 40 provides the carbon material of any one of Aspects 1-39, wherein the carbon material preferentially catalyzes electrochemical conversion of a gaseous composition comprising CO₂ and also comprising SO₂, SO₃, NO₂, NO₃, or a combination thereof, to CO over electrochemical conversion of the SO₂, SO₃, NO₂, NO₃, or a combination thereof.

Aspect 41 provides the carbon material of any one of Aspects 1-40, wherein the carbon material catalyzes electrochemical reduction of CO₂ to CO.

Aspect 42 provides the carbon material of Aspect 41, wherein the carbon material has a Faradaic Efficiency for reduction of CO₂ to CO of 0.1% to 100% from −0.1 V to −10 V.

Aspect 43 provides the carbon material of any one of Aspects 41-42, wherein the carbon material has a Faradaic Efficiency for reduction of CO₂ to CO of 90% to 99% from −0.8 V to −1.4 V, or from −0.2 V to −1.6 V, or from 0 V to −5 V.

Aspect 44 provides the carbon material of any one of Aspects 1-43, wherein the carbon material preferentially catalyzes electrochemical reduction CO₂ to CO over electrochemical conversion of a hydrogen source and CO₂ to CO and H₂.

Aspect 45 provides a carbon material comprising:
a mesoporous carbon matrix comprising a metal M, wherein M is bonded directly to the carbon matrix, M is bonded directly to a nitrogen atom that is bonded directly to the carbon matrix, or a combination thereof;
wherein M is Ni^{II}, M is 0.1 wt % to 5 wt % of the carbon matrix, and the carbon material has a Faradaic Efficiency for reduction of CO₂ to CO of 90% to 99% from −0.8 V to −1.4 V, or from −0.2 V to −1.6 V, or from 0 V to −5 V.

Aspect 46 provides an electrolytic cell comprising:
an electrode and/or electrolyte that comprises the carbon material of any one of Aspects 1-45.

Aspect 47 provides the electrolytic cell of Aspect 46, wherein the electrode is a cathode and the electrode comprises the carbon material.

Aspect 48 provides the electrolytic cell of any one of Aspects 46-47, wherein the electrode is an anode and the electrode comprises the carbon material.

Aspect 49 provides the electrolytic cell of any one of Aspects 46-48, wherein a coating on the electrode comprises the carbon material.

Aspect 50 provides the electrolytic cell of any one of Aspects 46-49, further comprising an ion-exchange membrane that separates the electrode including the carbon material from another electrode.

Aspect 51 provides the electrolytic cell of any one of Aspects 46-50, wherein the electrode comprises the carbon material, further comprising an electrolyte solution that at least partially immerses the electrode.

Aspect 52 provides the electrolytic cell of any one of Aspects 46-51, wherein the electrolyte comprises CO₂ (g).

Aspect 53 provides the electrolytic cell of any one of Aspects 46-52, wherein the electrolyte comprises a gaseous composition comprising CO₂, wherein the gaseous composition has a concentration of the CO₂ of 1% to 100%.

Aspect 54 provides the electrolytic cell of 53, wherein the gaseous composition further comprises SO₂, SO₃, NO₂, NO₃, or a combination thereof.

Aspect 55 provides an electrolytic cell comprising:
an anode;
a cathode;
an ion exchange membrane separating the anode and the cathode; and
an electrolyte solution at least partially immersing the anode and the cathode;
wherein the anode, the cathode, the electrolyte solution, or a combination thereof, comprises a carbon material comprising
   a mesoporous carbon matrix comprising a metal M, wherein M is bonded directly to the carbon matrix, M is bonded directly to an atom A that is bonded directly to the carbon matrix, or a combination thereof, wherein at each occurrence A is independently chosen from N, O, P, S, and B.

Aspect 56 provides a method of using an electrolytic cell, the method comprising:
applying an electrical potential across an anode and a cathode of an electrolytic cell, wherein the anode, the cathode, an electrolyte solution of the electrolytic cell, or a combination thereof, comprises a carbon material comprising
   a mesoporous carbon matrix comprising a metal M, wherein M is bonded directly to the carbon matrix, M is bonded directly to an atom A that is bonded directly to the carbon matrix, or a combination thereof, wherein at each occurrence A is independently chosen from N, O, P, S, and B.

Aspect 57 provides a method of electrochemical carbon dioxide reduction, the method comprising
applying an electrical potential across an anode and a cathode of an electrolytic cell, wherein the anode, the cathode, an electrolyte solution of the electrolytic cell, or a combination thereof, comprises a carbon material and is in contact with CO₂, to form CO;
wherein the carbon material comprises
   a mesoporous carbon matrix comprising a metal M, wherein M is bonded directly to the carbon matrix, M is bonded directly to a nitrogen atom that is bonded directly to the carbon matrix, or a combination thereof, and
   wherein M is Ni^{II}, M is 0.1 wt % to 5 wt % of the carbon matrix, and the carbon material has a Faradaic Efficiency for reduction of CO₂ to CO of 90% to 99% from −0.8 V to −1.4 V, or from −0.2 V to −1.6 V, or from 0 V to −5 V.

Aspect 58 provides the method of Aspect 57, wherein a gaseous composition comprises the CO₂ in contact with the anode, the cathode, the electrolyte solution, or the combination thereof, wherein the gaseous composition has a concentration of the CO₂ of 1% to 100%.

Aspect 59 provides the method of Aspect 58, wherein the gaseous composition further comprises SO₂, SO₃, NO₂, NO₃, or a combination thereof, wherein the carbon material preferentially converts the CO₂ to CO over conversion of the SO₂, SO₃, NO₂, NO₃, or a combination thereof.

Aspect 60 provides a method of making the carbon material of any one of Aspects 1-45, the method comprising:
chelating metal M with an organic amine;
combining a carbon source and a removable pore former with the chelated metal, to form a mixture;
heating the mixture to form a solid;
carbonizing the solid, to form a carbon material precursor; and
removing the removable pore former from the carbon material precursor, to form the carbon material.

Aspect 61 provides the method of Aspect 60, wherein the organic amine is H₂N—(CH₂)n-NH₂, wherein n is an integer in the range of 1 to 10, or methylenediamine dihydrochloride, N,N,N′N′-tetramethyldiaminomethane, ethylenediamine dichloride, hexamethylenetetramine, imidazolidine, histidine, di-(2-picolyl)amine, diethylenetriamine, tris((1H-benzo[d]imidazole-2-yl)methyl)amine, tris(pyridine-2-ylmethyl)amine, N¹,N¹-bis(2-(dimethylamine)ethyl)-N²,N²-dimethylethane-1,2-diamine, Ni-(2-(dimethylamine)ethyl)-N¹,N²,N²-trimethylethane-1,2-diamine, Ni-(2-aminoethyl)ethane-1,2-diamine, N¹,N¹-bis(2-aminoethyl)ethane-1,2-diamine, 2-hydroxyethylamine, 2-mercaptoethylamine, 2-(diphenylphosphino)ethylamine, 1,2-bis(diphenylphosphino)ethane, or a combination thereof. The organic amine can include two or more nitrogen atoms per molecule. More than one organic amine can be used, wherein at least one of the organic amines includes two or more nitrogen atoms per molecule.

Aspect 62 provides the method of any one of Aspects 60-61, wherein the organic amine is ethylenediamine.

Aspect 63 provides the method of any one of Aspects 60-62, wherein the carbon source is a carbon tetrahalide, methylene chloride, 1,1,2,2-tetrachloroethane, 1,1,2,2-tetrabromoethane, perchloroethene, chloroform, bromoform, perbromomethane, or a combination thereof.

Aspect 64 provides the method of any one of Aspects 60-63, wherein the carbon source is carbon tetrachloride.

Aspect 65 provides the method of any one of Aspects 60-64, wherein the removable pore former comprises a pyrolyzable material, a meltable material, a heat-degradable material, an acid- or base-etchable material, or a combination thereof.

Aspect 66 provides the method of any one of Aspects 60-65, wherein the removable pore former comprises mesoporous silica.

Aspect 67 provides the method of Aspect 66, wherein the mesoporous silica has a pore diameter of 1 nm to 50 nm.

Aspect 68 provides the method of any one of Aspects 66-67, wherein the mesoporous silica has a pore diameter of 5 nm to 15 nm.

Aspect 69 provides the method of any one of Aspects 66-68, wherein the mesoporous silica has a particle size of 20 nm to 500 nm.

Aspect 70 provides the method of any one of Aspects 66-69, wherein the mesoporous silica has a particle size of 20 nm to 150 nm.

Aspect 71 provides the method of any one of Aspects 66-70, wherein the mesoporous silica has a pore volume of 0.4-1.5 cm³/g.

Aspect 72 provides the method of any one of Aspects 66-71, wherein the mesoporous silica has a pore volume of 0.8-1 cm³/g.

Aspect 73 provides the method of any one of Aspects 60-72, wherein heating the mixture to form the solid comprises heating the mixture at a temperature of 50° C. to 150° C.

Aspect 74 provides the method of any one of Aspects 60-73, wherein heating the mixture to form the solid comprises heating the mixture at a temperature of 80° C. to 100° C.

Aspect 75 provides the method of any one of Aspects 60-74, wherein heating the mixture to form the solid comprises heating the mixture under ambient pressure.

Aspect 76 provides the method of any one of Aspects 60-75, wherein heating the mixture to form the solid comprises heating the mixture for a duration of 10 h to 20 h.

Aspect 77 provides the method of any one of Aspects 60-76, wherein carbonizing the solid comprises heating the solid at a temperature of 600° C. to 1000° C.

Aspect 78 provides the method of any one of Aspects 60-77, wherein carbonizing the solid comprises heating the solid at a temperature of 700° C. to 900° C.

Aspect 79 provides the method of any one of Aspects 60-78, wherein carbonizing the solid comprises heating the solid under an inert gas.

Aspect 80 provides the method of any one of Aspects 60-79, wherein carbonizing the solid comprises heating the solid for a duration of 10 min to 20 h.

Aspect 81 provides the method of any one of Aspects 60-80, wherein the removing comprises etching, heating, or a combination thereof.

Aspect 82 provides the method of any one of Aspects 60-81, wherein the removing comprises etching comprising treatment with acid or base.

Aspect 83 provides the method of Aspect 82, wherein the etching comprises treatment with HF, sodium hydroxide, or potassium hydroxide.

Aspect 84 provides the method of any one of Aspects 60-83, wherein an oxidation state of metal M prior to the chelation is the same as an oxidation state of metal M in the carbon material.

Aspect 85 provides the method of any one of Aspects 60-84, wherein a coordination number of metal M prior to the chelation is the same as a coordination number of metal M in the carbon material.

Aspect 86 provides the method of any one of Aspects 60-85, wherein chelating the organic amine and the metal M comprises chelating the organic amine and an organometallic compound comprising M and one or more counterions.

Aspect 87 provides the method of any one of Aspects 60-86, wherein chelating the organic amine and the metal M comprises chelating the organic amine and an organometallic compound comprising M and one or more acetylacetonate counterions thereon.

Aspect 88 provides a method of making a carbon material, the method comprising:
chelating metal M with an organic amine;
combining a carbon source and a removable pore former with the chelated metal, to form a mixture;
heating the mixture to form a solid;
carbonizing the solid, to form a carbon material precursor; and
removing the removable pore former from the carbon material precursor, to form the carbon material comprising
   a mesoporous carbon matrix comprising a metal M, wherein M is bonded directly to the carbon matrix, M is bonded directly to an atom A that is bonded directly to the carbon matrix, or a combination thereof, wherein at each occurrence A is independently chosen from N, O, P, S, and B.

Aspect 89 provides the carbon material, method, or electrolytic cell of any one or any combination of Aspects 1-88 optionally configured such that all elements or options recited are available to use or select from.

What is claimed is:

1. A carbon material comprising:
a mesoporous carbon matrix comprising a metal M, wherein M is bonded directly to the carbon matrix, M is bonded directly to an atom A that is bonded directly to the carbon matrix, or a combination thereof, wherein at each occurrence A is independently chosen from O, N, P, S, and B.

2. The carbon material of claim 1, wherein A is N.

3. The carbon material of claim 1, wherein M is bonded to the carbon matrix as M-C^{M}₄, C^{M}₃-M-AC^{M}, C^{M}₂-M-(AC^{M})₂, C^{M}-M-(AC^{M})₃, M-(AC^{M})₄, M-C^{M}₃, C^{M}₂-M-AC^{M}, C^{M}-M-(AC^{M})₂, M-(AC^{M})₃, or a combination thereof, wherein at each occurrence C^{M} is independently chosen from a carbon atom of the carbon matrix.

4. The carbon material of claim 1, wherein M is bonded to the carbon matrix as C^{M}-M-(AC^{M})₃, wherein at each occurrence C^{M} is independently chosen from a carbon atom of the carbon matrix.

5. The carbon material of claim 1, wherein the carbon material further comprises metal nanoparticles comprising metal M.

6. The carbon material of claim 1, wherein the mesoporous carbon matrix comprises mesopores having a pore diameter of 1 nm to 50 nm.

7. The carbon material of claim 1, wherein the carbon material has a surface area of 100 to 2500 m²/g.

8. The carbon material of claim 1, wherein M is 0.1 wt % to 40 wt % of the carbon matrix.

9. The carbon material of claim 1, wherein M is Zn, Al, Sn, Ga, In, Ge, Fe, Co, Ni, Cu, Pt, Pd, Ru, or Rh.

10. The carbon material of claim 1, wherein M is Ni^{II}.

11. The carbon material of claim 1, wherein A is 0.1 wt % to 60 wt % of the carbon material and wherein carbon is 40 wt % to 99.9 wt % of the carbon material.

12. The carbon material of claim 1, wherein A is N and wherein N is 0.1 wt % to 60 wt % of the carbon material.

13. The carbon material of claim 1, wherein the mesoporous carbon matrix has a C:A atomic ratio of 1 to 50.

14. An electrolytic cell comprising:
an electrode and/or electrolyte that comprises the carbon material of claim 1.

15. A method of electrochemical carbon dioxide reduction, the method comprising
applying an electrical potential across an anode and a cathode of an electrolytic cell, wherein the anode, the cathode, an electrolyte solution of the electrolytic cell, or a combination thereof comprises a carbon material and is in contact with CO₂, to form CO;
wherein the carbon material comprises
a mesoporous carbon matrix comprising a metal M, wherein M is bonded directly to the carbon matrix, M is bonded directly to a nitrogen atom that is bonded directly to the carbon matrix, or a combination thereof, and
wherein M is Ni^{II}, M is 0.1 wt % to 5 wt % of the carbon matrix, and the carbon material has a Faradaic Efficiency for reduction of CO₂ to CO of 90% to 99% from −0.8 V to −1.4 V.

16. The method of claim 15, wherein a gaseous composition comprises the CO₂, wherein the gaseous composition has a concentration of the CO₂ that is 1-100%.

17. The method of claim 16, wherein the gaseous composition further comprises SO₂, SO₃, NO₂, NO₃, or a combination thereof, wherein the electrolytic cell preferentially converts the CO₂ to CO over conversion of the SO₂, SO₃, NO₂, NO₃, or a combination thereof.

18. A method of making the carbon material of claim 1, the method comprising:
chelating metal M with an organic amine;
combining a carbon source and a removable pore former with the chelated metal, to form a mixture;
heating the mixture to form a solid;
carbonizing the solid, to form a carbon material precursor; and
removing the removable pore former from the carbon material precursor, to form the carbon material of claim 1.

19. The method of claim 18, wherein the organic amine includes at least two nitrogen atoms per molecule.

20. The method of claim 18, wherein the organic amine is H₂N—(CH₂)n-NH₂, wherein n is an integer in the range of 1 to 10, or methylenediamine dihydrochloride, N,N,N′N′-tetramethyldiaminomethane, ethylenediamine dichloride, hexamethylenetetramine, imidazolidine, histidine, di-(2-picolyl)amine, diethylenetriamine, tris((1H-benzo[d]imidazole-2-yl)methyl)amine, tris(pyridine-2-ylmethyl)amine, N¹,Ni-bis(2-(dimethylamine)ethyl)-N²,N²-dimethylethane-1,2-diamine, Ni-(2-(dimethylamine)ethyl)-N¹,N²,N²-trimethylethane-1,2-diamine, N¹-(2-aminoethyl)ethane-1,2-diamine, N¹,Ni-bis(2-aminoethyl)ethane-1,2-diamine, 2-hydroxyethylamine, 2-mercaptoethylamine, 2-(diphenylphosphino)ethylamine, 1,2-bis(diphenylphosphino)ethane, or a combination thereof.
